(19) United States
(12) Patent Application Publication
(10) Pub. No.: US 2024/0184858 A1
(43) Pub. Date: Jun. 6, 2024

(54) METHODS AND MECHANISMS FOR AUTOMATIC SENSOR GROUPING TO IMPROVE ANOMALY DETECTION

(71) Applicant: Applied Materials, Inc., Santa Clara, CA (US)

(72) Inventors: Peter J. Lindner, Saratoga Springs, NY (US); John G. Albright, Stone Ridge, NY (US); Jimmy Iskandar, Fremont, CA (US); Michael D. Armacost, San Jose, CA (US)

(21) Appl. No.: 18/075,055

(22) Filed: Dec. 5, 2022

(51) Int. Cl. G06F 18/25; G06F 18/21; G06F 18/2113; G06F 18/23; G06F 18/2433

(52) U.S. Cl. CPC G06F 18/25; G06F 18/2113; G06F 18/2193; G06F 18/23; G06F 18/2433

(57) ABSTRACT

An electronic device manufacturing system configured to obtain, by a processor, a plurality of datasets associated with a process recipe, wherein each dataset of the plurality of datasets comprises data generated by a plurality of sensors during a corresponding process run performed using the process recipe. The processor is further configured to determine, using the plurality of data sets associated with the process recipe, a correlation value between two or more sensors of the plurality of sensors. Responsive to the correlation value satisfying a threshold criterion, the processor assigns the two or more sensors to a cluster. During a subsequent process run, the processor generates an anomaly score associated with the cluster and indicative of an anomaly associated with at least one step of the subsequent process run.

### TECHNICAL FIELD

The present disclosure relates to electrical components, and, more particularly, to methods and mechanisms for improving anomaly detection by automatically grouping sensors.

### BACKGROUND

Manufacturing of modern materials often involves various deposition techniques, such as chemical vapor deposition (CVD) or physical vapor deposition (PVD) techniques, in which atoms or molecules of one or more selected types are deposited on a semiconductor device (e.g., a substrate) held in low or high vacuum environments that are provided by vacuum processing (e.g., deposition, etching, etc.) chambers. Materials manufactured in this manner can include monocrystals, semiconductor films, fine coatings, and numerous other substances used in practical applications, such as electronic device manufacturing. Many of these applications depend on the purity and specifications of the materials grown in the processing chambers. The quality of such materials, in turn, depends on adherence of the manufacturing operations to correct process specifications. To maintain isolation of the inter-chamber environment and to minimize exposure of substrates to ambient atmosphere and contaminants, various sensor detection techniques are used to monitor processing chamber environment, substrate transportation, physical and chemical properties of the products, and the like to detect potential anomalies and issues.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, an electronic device manufacturing system configured to obtain, by a processor, a plurality of datasets associated with a process recipe, wherein each dataset of the plurality of datasets comprises data generated by a plurality of sensors during a corresponding process run performed using the process recipe. The processor is further configured to determining, using the plurality of data sets associated with the process recipe, a correlation value between two or more sensors of the plurality of sensors. Responsive to the correlation value satisfying a threshold criterion, the processor assigns the two or more sensors to a cluster. During a subsequent process run, the processor generates an anomaly score associated with the cluster and indicative of an anomaly associated with at least one step of the subsequent process run.

A further aspect of the disclosure includes a method according to any aspect or embodiment described herein.

A further aspect of the disclosure includes a non-transitory computer-readable storage medium comprising instructions that, when executed by a processing device operatively coupled to a memory, performs operations according to any aspect or embodiment described herein.

### BRIEF DESCRIPTION OF THE DRAWINGS

The present disclosure is illustrated by way of example, and not by way of limitation in the figures of the accompanying drawings.

FIG. 1 is a block diagram illustrating an example system architecture, in accordance with some implementations of the present disclosure.

FIG. 2 is a top schematic view of an example manufacturing system, in accordance with some implementations of the present disclosure.

FIG. 3 is a block diagram illustrating an example predictive architecture, in accordance with some implementations of the present disclosure.

FIG. 4 is an exemplary illustration of a machine learning system that is capable of anomaly detection based on aggregate statistics using neural networks, in accordance with some implementations of the present disclosure.

FIG. 5 is an exemplary illustration of a reduction stage of anomaly detection based on aggregate statistics using neural networks, in accordance with some implementations of the present disclosure.

FIG. 6 is an exemplary illustration of a detection stage of anomaly detection based on aggregate statistics using neural networks, in accordance with some implementations of the present disclosure.

FIG. 7 is an exemplary neural network that operates as a detector neural network used in the detection stage of anomaly detection based on aggregate statistics using neural networks, in accordance with some implementations of the present disclosure.

FIG. 8 is a flow chart of a method for generating sensor cluster data, in accordance with some implementations of the present disclosure.

FIG. 9 is a data table illustrating a set of arrays and their corresponding cluster identifier, in accordance with some implementations of the present disclosure.

FIG. 10 is a flow diagram of one possible implementation of a method of anomaly detection based on aggregate statistics, in accordance with some implementations of the present disclosure.

FIG. 11 is a graph showing output data, for a particular cluster, generated by the ADM, according to aspects of the present disclosure.

FIG. 12A is another graph showing output data, for a particular cluster, generated by the ADM, according to aspects of the present disclosure.

FIGS. 12B-12D are graphs, respectively, showing sensor statistic output data for respective sensor of the sensor cluster, according to aspects of the present disclosure.

FIG. 13 is a block diagram illustrating a computer system, according to certain embodiments.

### DETAILED DESCRIPTION

Described herein are technologies directed to methods and mechanisms for improving anomaly detection by automatically grouping sensors. The implementations disclosed provide for universal handling of large amounts of statistical data from multiple sensors supplying data about the manufacturing system and processes performed therein. For example, the implementations disclosed can help accurately detect when an anomaly in a manufacturing process and/or a product of the process arises that indicates a deterioration of the product yield, and to determine whether the anomaly is related to an issue in a sub-system, an issue in a particular component, etc. A sub-system can refer to a pressure sub-system, a flow sub-system, a temperature sub-system and so forth, each sub-system having one or more components. The component can include, for example, a pressure pump, a vacuum, a gas deliver line, etc.

The robotic delivery and retrieval of substrates, as well as maintaining controlled environments in loading, processing, and transfer chambers improve speed, efficiency, and quality of the semiconductor device manufacturing. Typical semiconductor device manufacturing processes often require tens or hundreds of steps, e.g., introducing a gas into a processing chamber, heating the chamber environment, changing a composition of gas, purging a chamber, pumping the gas out, changing pressure, moving a substrate from one position to another, creating or adjusting a plasma environment, performing etching or deposition steps, and so on. The very complexity of the semiconductor manufacturing technology requires processing a constant stream of run-time data from various sensors placed inside the manufacturing system. Such sensor can include temperature sensors, pressure sensors, chemical sensors, gas flow sensors, motion sensors, position sensor, optical sensors, and other types of sensors. The manufacturing system can have multiple sensors of the same (or similar) type distributed throughout various parts of the system. For example, a single processing chamber can have multiple chemical sensors to detect concentration of chemical vapor at various locations within the processing chamber and can similarly have multiple temperature sensors to monitor a temperature distribution. Some or all of the sensors can output a constant stream of data. For example, a temperature sensor can output a temperature reading ever second (or more frequently) so that a single etching step that takes several minutes to perform can be generate hundreds of data points from this sensor alone.

Each sensor (alone or in combination with other sensors) can output data that is indicative of a sudden or gradual detrimental changes in the environment or in the settings of the manufacturing process. In some systems, a detection system can read the data and monitor whether the manufacturing process conforms to the process specifications. However, current systems typically feed all available sensor data into the detection system. Such a large number of sensors providing data about multiple substrates being processed in multiple chambers can cause large variability, which can cause difficultly in identifying and classifying anomalies in the data obtained from particular sensors. This can cause the detection system to generate false positives and/or false negatives, resulting in inaccurate diagnostics. Furthermore, the large datasets generated by obtaining data from hundreds or thousands of sensors can require a large processing time. This can cause the detection system to experience increased latency, which can result in missed opportunities to perform adjustments and other corrective actions during the manufacturing process, leading to defective substrates.

Aspects and implementations of the present disclosure address these and other shortcomings of the existing technology by automatically grouping sensors to improve manufacturing anomaly detection. In particular, a process chamber of a semiconductor device manufacturing equipment can perform each substrate manufacturing process (e.g., a deposition process, a etch process, a polishing process, etc.) according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc. For each step of the process recipe, sensors within the manufacturing equipment can generate raw sensor data related to these and other settings (e.g., measured temperature during each step, measured pressure during each step, etc.). A client device operatively coupled to the manufacturing equipment can then determine statistics representative of the sensor data (e.g., statistics data, such as, a mean, a median, a mode, an upper bound, a lower bound, a variance (or a standard deviation), a skewness (third moment), a kurtosis (fourth moment), etc). For each process run (e.g., the execution of a particular recipe on a substrate), these data items related to the execution of a recipe (e.g., the statistics data, the sensor data, contextual data such as recipe identifier, a recipe step number(s), etc.) can be collected and stored (referred to as a “process run dataset”). In some embodiments, the data items can first be combined into multiple “arrays.” An array can include a combination of data items according to a predefined format or pattern. In some embodiments, each array can include a particular sensor (e.g., chamber pressure sensor, heater current sensor, etc.), a statistic data type (e.g., mean, range, etc.), and a recipe portion identifier (e.g., step 1, step 11, entire recipe, etc.). For example, an array can be indicative of the average heater temperature during step 5 of a particular process recipe.

In some embodiments, the client device can generate a training set consisting of multiple process run datasets. For example, the client device can obtain 100 process run datasets to generate the training set. The process run datasets can be selected by an operator, selected from the most recently runs of a particular substrate manufacturing process, etc. In some embodiments, the process run datasets can first be screened or filtered (e.g., via an anomaly detector) to ensure that no faults or significant deviations occurred. The client device can then perform one or more correlation methods to determine which sensors (or arrays) exhibit a strong relationship between each other. In some embodiments, a strong relationship can be identified when a correlation value(s) generated by the correlation method satisfied a threshold criterion (e.g., exceeds a threshold value). The correlation method can include the Pearson correlation method, the Kendall correlation method, Spearman's correlation method, the Quotient correlation method, the Phik correlation method, the SAX (Symbolic Aggregate approximation) correlation method, etc.

The client device can group together sensors (or arrays) that exhibit a strong relationship. For example, the client device can generate a Pearson coefficient value by applying the Pearson correlation method to two particular arrays of the training set (e.g., a process chamber's mean foreline pressure during step 1 of a particular recipe, and the process chamber's pressure range during step 1 of the particular recipe). Responsive to determining that the generate Pearson coefficient value exceeds a threshold criterion, the client device can assign the two arrays to a particular cluster (e.g., cluster 1). The client device can apply the correlation method to each possible pair of sensors or data arrays to determine whether said arrays exhibit a strong relationship and should be grouped.

Once the sensors or arrays are assigned to particular clusters, the client device can use the cluster data to obtain more comprehensive data when performing anomaly detection techniques (via an anomaly detector) on real-time data obtained during a substrate manufacturing process (or on stored data from historical substrate manufacturing processes). For example, if a fault occurs during a substrate manufacturing process, the anomaly detector can indicate whether a set of sensors belonging to the same cluster output anomalous data (which could be indicative of an issue in an entire sub-system, e.g., a pressure sub-system, a flow sub-system, a temperature subsystem, etc.) or whether one or more ungrouped sensors output the anomalous data (which could be indicative of an issue with a component, e.g., a pressure pump, a vacuum, a gas deliver line, etc.). In an illustrative example, for a thermocouple anomaly, if an entire cluster is anomalous, it could be due to a change in the process or a product affecting the temperature of a chamber. Alternatively, if just an individual thermocouple failed, it can be due to a specific sensor issue.

Aspects of the present disclosure result in technological advantages of improving the accuracy of manufacturing anomaly detection techniques during a manufacturing process. In one example, the aspects of the present disclosure can decrease the occurrence of false positives and false negatives of the anomaly detection technique. This can result in generating diagnostic data with fewer errors and inaccuracies, which can reduce fabrication of inconsistent and abnormal products, and prevent unscheduled user time or down time. Additionally, aspects of the present disclosure provide significant reduction in time and data required to process the sensor data to detect the possible anomalies.

Various aspects of the above referenced methods and systems are described in details herein below by way of examples, rather than by way of limitation. The embodiments and examples provided below are discussed in relation to manufacturing systems. However, it is noted that aspects of the present disclosure, such as those relating to automatically grouping sensors to improve anomaly detection, can be applied to other fields and industries, such as pharmaceuticals.

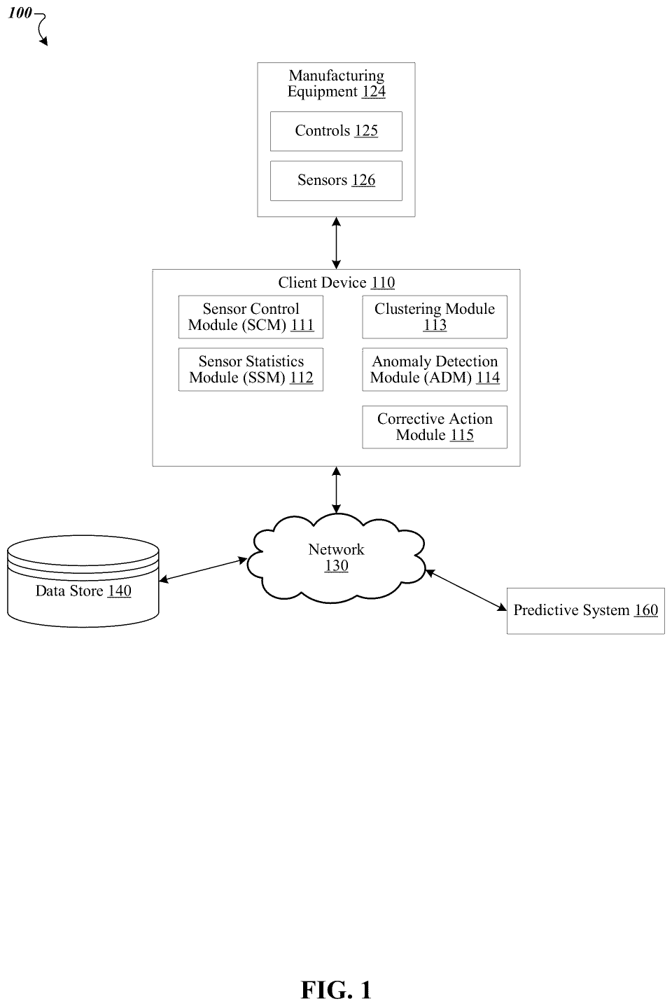

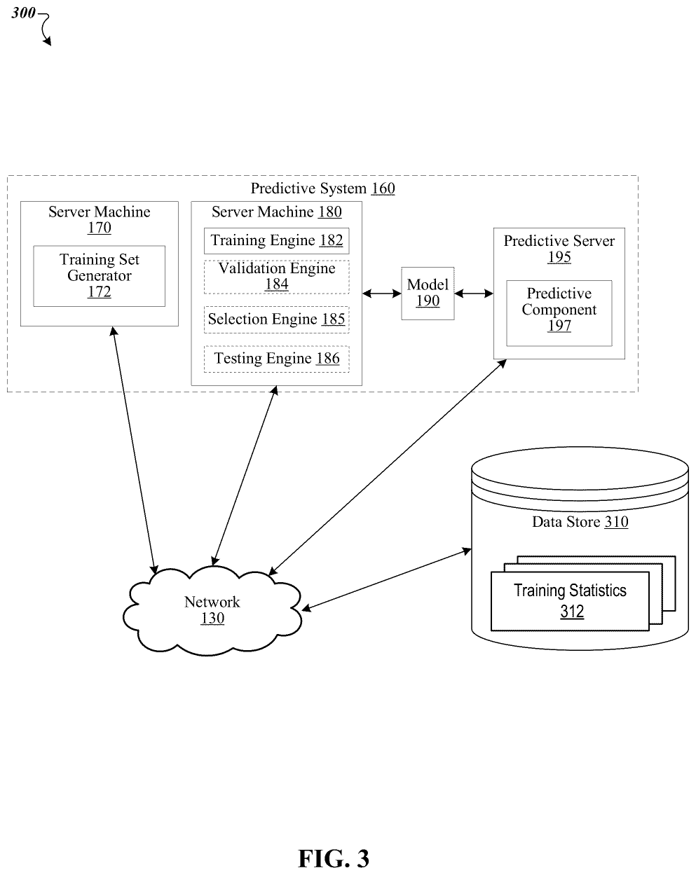

FIG. 1 depicts an illustrative computer system architecture 100, according to aspects of the present disclosure. In some embodiments, computer system architecture 100 can be included as part of a manufacturing system for processing substrates. Computer system architecture 100 includes a client device 120, manufacturing equipment 124, predictive system 160 (e.g., to generate predictive data, to provide model adaptation, to use a knowledge base, etc., which will be described in detail in FIG. 3), and data store 140. The manufacturing equipment 124 can include sensors 126 configured to capture data for a substrate being processed at the manufacturing system. In some embodiments, the manufacturing equipment 124 and sensors 126 can be part of a sensor system that includes a sensor server (e.g., field service server (FSS) at a manufacturing facility) and sensor identifier reader (e.g., front opening unified pod (FOUP) radio frequency identification (RFID) reader for sensor system). In some embodiments, metrology equipment can be part of computer system architecture 100 that includes a metrology server (e.g., a metrology database, metrology folders, etc.) and metrology identifier reader (e.g., FOUP RFID reader for metrology system).

Manufacturing equipment 124 can produce products, such as electronic devices, following a recipe or performing runs over a period of time. Manufacturing equipment 124 can include a process chamber. Manufacturing equipment 124 can perform a process for a substrate (e.g., a wafer, etc.) at the process chamber. Examples of substrate processes include a deposition process to deposit one or more layers of film on a surface of the substrate, an etch process to form a pattern on the surface of the substrate, etc. Manufacturing equipment 124 can perform each process according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc.

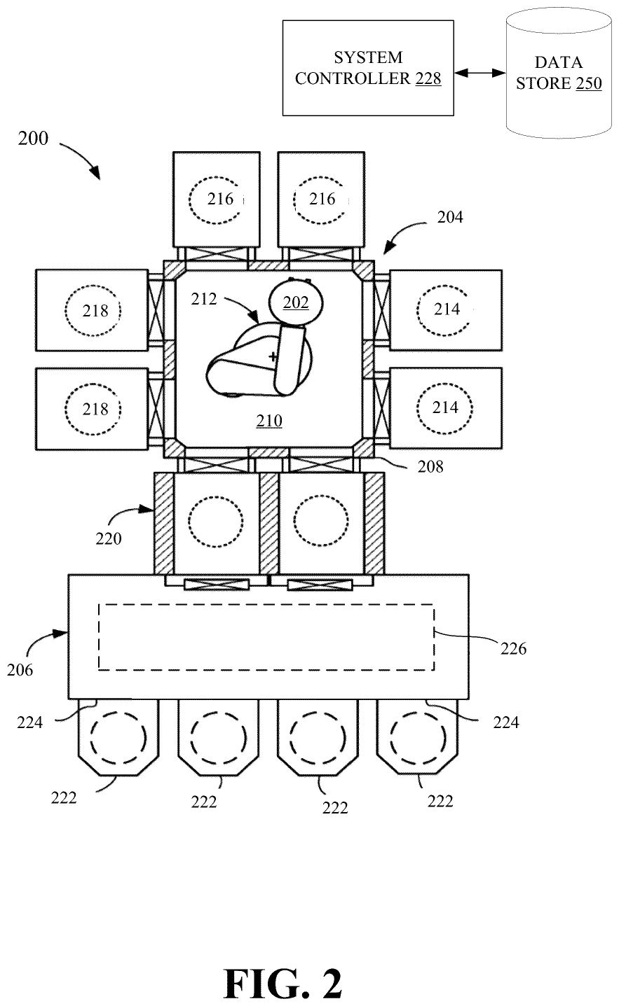

In some embodiments, manufacturing equipment 124 includes sensors 126 that are configured to generate data associated with a substrate processed at manufacturing system 100. For example, a process chamber can include one or more sensors configured to generate spectral or non-spectral data associated with the substrate before, during, and/or after a process (e.g., a deposition process, an etch process, etc.) is performed for the substrate. In some embodiments, spectral data generated by sensors 126 can indicate a concentration of one or more materials deposited on a surface of a substrate. Sensors 126 configured to generate spectral data associated with a substrate can include reflectometry sensors, ellipsometry sensors, thermal spectra sensors, capacitive sensors, and so forth. Sensors 126 configured to generate non-spectral data associated with a substrate can include temperature sensors, pressure sensors, flow rate sensors, voltage sensors, etc. For example, each sensor 126 can be a temperature sensor, a pressure sensor, a chemical detection sensor, a chemical composition sensor, a gas flow sensor, a motion sensor, a position sensor, an optical sensor, or any and other type of sensors. Some or all of the sensors 126 can include a light source to produce light (or any other electromagnetic radiation), direct it towards a target, such as a component of the machine 100 or a substrate, a film deposited on the substrate, etc., and detect light reflected from the target. The sensors 126 can be located anywhere inside the manufacturing equipment 124 (for example, within any of the chambers including the loading stations, on one or more robots, on a robot blade, between the chambers, and so one), or even outside the manufacturing equipment 124 (where the sensors can test ambient temperature, pressure, gas concentration, and so on). Further details regarding manufacturing equipment 124 are provided with respect to FIG. 2.

In some embodiments, sensors 126 provide sensor data (e.g., sensor values, features, trace data) associated with manufacturing equipment 124 (e.g., associated with producing, by manufacturing equipment 124, corresponding products, such as substrates). The manufacturing equipment 124 can produce products following a recipe or by performing runs over a period of time. Sensor data received over a period of time (e.g., corresponding to at least part of a recipe or run) can be referred to as trace data (e.g., historical trace data, current trace data, etc.) received from different sensors 126 over time. Sensor data can include a value of one or more of temperature (e.g., heater temperature), spacing (SP), pressure, high frequency radio frequency (HFRF), voltage of electrostatic chuck (ESC), electrical current, material flow, power, voltage, etc. Sensor data can be associated with or indicative of manufacturing parameters such as hardware parameters, such as settings or components (e.g., size, type, etc.) of the manufacturing equipment 124, or process parameters of the manufacturing equipment 124. The sensor data can be provided while the manufacturing equipment 124 is performing manufacturing processes (e.g., equipment readings when processing products). The sensor data can be different for each substrate.

In some embodiments, manufacturing equipment 124 can include controls 125. Controls 125 can include one or more components or sub-systems configured to enable and/or control one or more processes of manufacturing equipment 124. For example, a sub-system can include a pressure sub-system, a flow sub-system, a temperature sub-system and so forth, each sub-system having one or more components. The component can include, for example, a pressure pump, a vacuum, a gas deliver line, a plasma etcher, actuators etc. In some embodiments, controls 125 can be managed based on data from sensors 126, input from control device 120, etc.

The client device 110 can include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. In some embodiments, the sensor data (or other data items) can be received from the client device 110. Client device 110 can display a graphical user interface (GUI), where the GUI enables the user to provide, as input, setting or parameters associated with clustering or anomaly detection operations (e.g., types of datasets, amount of datasets, number or which process chamber(s), selection of the algorithm(s), etc.). The client device 110 can include sensor control module (SCM) 111, sensor statistic module (SSM) 112, clustering module 113, anomaly detection module 114, and corrective action module 115,

The SCM 111 can activate sensors, deactivate sensors, place sensors in an idle state, change settings of the sensors, detect sensor hardware or software problems, and so on. In some implementations, the SCM 111 can keep track of the processing operations performed by the manufacturing equipment 124 and determine which sensors 126 to be sampled for a particular processing (or diagnostic, maintenance, etc.) operation of the manufacturing equipment 124. For example, during a chemical deposition step inside one of the processing chambers, the SCM 111 can sample sensors 126 that are located inside the respective processing chamber but not activate (or sample) sensors 126 located inside the transfer chamber and/or the loading station. The raw data obtained by the SCM 111 can include time series data where a specific sensor 126 captures or generates one or more readings of a detected quantity at a series of times. For example, a pressure sensor can generate N pressure readings P(tᵢ) at time instances t₁, t₂, . . . t_{N}. In some implementations, the raw data obtained by the SCM 111 can include spatial maps at a pre-determined set of spatial locations. For example, an optical reflectivity sensor can determine reflectivity of a film deposited on the surface of a wafer, R(xⱼ, yₗ), at a set (e.g., a two-dimensional set) of spatial locations xⱼ, yₖ, on the surface of the film/wafer. In some implementations, both the time series and the spatial maps raw data can be collected. For example, as the film is being deposited on the wafer, the SCM 111 can collect the reflectivity data from various locations on the surface of the film and at a set of consecutive instances of time, R(tᵢ, xⱼ, yₗ).

SSM 112 can process the raw data obtained by the SCM 111 from the sensors 126 and determine statistics representative of the raw data (referred to as “statistics data”). For example, for each or some of the raw sensor data distributions, the SSM 112 can determine one or more parameters of the distribution, such as a mean, a median, a mode, an upper bound, a lower bound, a variance (or a standard deviation), a skewness (third moment), a kurtosis (fourth moment), or any further moments or cumulants of the data distribution. In some implementations, the SSM 112 can model (e.g., via regression analysis fitting) the raw data with various model distributions (normal distribution, log-normal distribution, binomial distribution, Poisson distribution, Gamma distribution, or any other distribution. In such implementations, the one or more parameters can include an identification of the fitting distribution being used together with the fitting parameters determined by the SSM 112. In some embodiments, the SSM 112 can use multiple distributions to fit the raw data from one sensor, e.g., a main distribution and a tail distribution for outlier data points. The parameters of the distributions obtained by the SSM 112 can be sensor-specific. For example, for some sensors a small number of parameters can be determined (mean, median, variance) whereas for some sensor many more (e.g., 10 or 20) moments can be determined.

Clustering module 113 can be configured to group, into one or more clusters, one or more data items related to the manufacturing process. In some embodiments, the data item can include sensor data, task data, contextual data, statistics data, etc. In some embodiments, the data items can first be combined into a set(s) of “arrays.” An array can include a combination of data items according to a predefined format or pattern. In some embodiments, each array can include a particular sensor (e.g., chamber pressure sensor, heater current sensor, etc.), a statistic data type (e.g., mean, range, etc.), and a recipe portion identifier (e.g., step 1, step 11, entire recipe, etc.). For example, an array can be indicative of the average heater voltage during step 3 of a particular process recipe.

To group the data items or arrays into one or more clusters, the clustering module 113 can use one or more correlation methods capable of determining or inferring relationships between data items. In some embodiments, the correlation methods include Pearson correlation method (Pearson correlation coefficient), Kendall correlation method (Kendall rank correlation coefficient), Spearman's correlation method (Spearman's rank correlation coefficient), Quotient correlation method, the Phik correlation method, the SAX (Symbolic Aggregate approximation) correlation method, or any other statistic method capable of determining a correlation between two sets of data. The Pearson correlation method can measure the strength of a linear correlation between two variables. In particular, Pearson correlation can be used to generate a coefficient indicative of a ratio between the covariance of two variables and the product of their standard deviation. Using the Pearson correlation method, clustering module 113 can assign a coefficient (e.g., a value) between −1 and 1, where 0 is no correlation, 1 is total positive correlation, and −1 is total negative correlation between the variables (or sets of data). For example, a correlation value of 0.7 between variables indicates that a significant and positive relationship exists. A positive correlation signifies that if variable A goes up, then B will also go up, whereas if the value of the correlation is negative, then if A increases, B decreases.

Kendall correlation method is a statistic used to measure the ordinal association between two measured quantities. In particular, Kendall correlation measures the strength and direction of association that exists between two variables. Spearman's correlation method is a nonparametric measure of rank correlation, e.g., the statistical dependence between the rankings of two variables. Spearman's correlation can assess how well the relationship between two variables can be described using a monotonic function. The Quotient correlation method is a sample based alternative to the Pearson correlation method that measures nonlinear dependence where the regular correlation coefficient is generally not applicable.

In some embodiments, clustering module 113 can use one or more machine learning models (e.g., model 190) to cluster data items into specific clusters. In particular, clustering module 113 can input data items into the machine learning model, and receive, as output, data indicative of clustering assignments (e.g., whether two data items should be clustered, which data items belong to which cluster, etc.) In some embodiments, the machine learning model can generate the output data using, for example, a K-means clustering algorithm, a density-based spatial clustering of applications with noise (DBSCAN) algorithm, a Spectral Clustering algorithm, a Ward clustering algorithm, a Birch clustering algorithm, or any other clustering algorithm. The machine learning model can be generated by the predictive system 160, which is discussed with regards to FIG. 3.

Based on a determined correlation between two data items or arrays, clustering module 113 can assign the data items or arrays to a particular cluster. In some embodiments, the clustering module 113 can determine a correlation value between two data items or arrays. In response to the correlation value satisfying a threshold criterion (e.g., being one or more of greater than, equal to, or less than a predetermine threshold value), clustering module 113 can assign the two data items or arrays to a particular cluster. For example, clustering module 113 can assign both data items to the next available cluster (e.g., cluster A, cluster 1, etc.). Clustering module 113 can continue to determine correlations between different data items. Responsive to a correlation value between an assigned data item (e.g., a data item assigned to cluster A) and an unassigned data item (a data item not assigned to a cluster) satisfying a threshold criterion, clustering module 113 can assign the unassigned data item to the same cluster as the assigned data item (e.g., assign the unassigned data item to cluster A). Responsive to a correlation value of two unassigned data items satisfying a threshold criterion, clustering module 113 can assigned both unassigned data items to a next unassigned cluster (e.g., cluster B. In some embodiments, data items that remain unassigned (e.g., those whose correlation value with all or a set of other data item failed to satisfy a threshold criterion) can remain unassigned or be assigned to a particular, predetermined cluster.

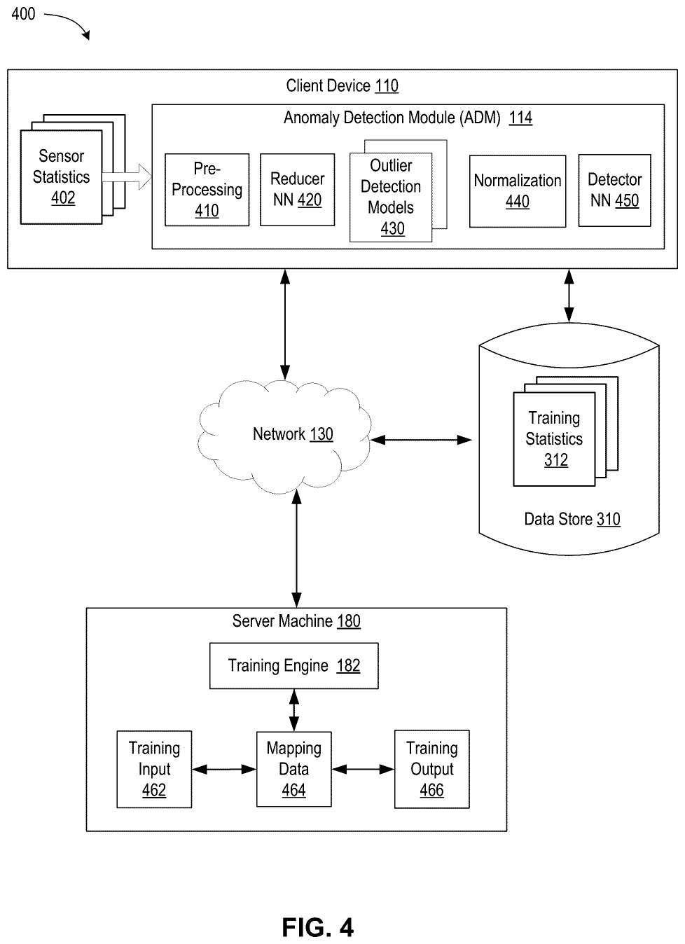

Anomaly detection module 114 can process, aggregate, and analyze the statistics collected by the SSM 112. In some embodiments, anomaly detection module 114 can pre-process, reduce the dimensionality of the sensor statistics, process the reduced representations of statistics by multiple anomaly detection models, normalize, and/or process using a detector neural network to determine one or more anomaly scores. At least some of the listed operations can include machine learning. In some embodiments, anomaly detection module 114 can one or more detection techniques, such as, for example, statistical anomaly detection techniques (e.g., Z-score, Tukey's range test, Grubb's test, etc.) ensemble techniques (e.g., the Anomaly Detection Ensemble (ADE) system, feature bagging techniques, score normalization techniques, etc.), fuzzy logic-based outlier detection techniques, Bayesian networks, hidden Markov models (HMMs), a Fourier transform method, a trace analysis method that generates adaptive “guardbands” on certain sensors, an anomaly detection neural network (ADN), or any other type of anomaly detection techniques. The machine learning model can be generated by the predictive system 160, which is discussed with regards to FIG. 3. An illustrative example for implementing an ADE system and performing anomaly detection using the ADE system is discussed with regards to FIGS. 4-7.

Corrective action module 115 can receive user input (e.g., via a Graphical User Interface (GUI) displayed via the client device 110) of an indication associated with manufacturing equipment 124. In some embodiments, the corrective action module 115 receives an input data from anomaly detection module 114, determines a corrective action based on the input data, and causes the corrective action to be implemented. For example, responsive to receiving an indication that sensor data relating to each sensor of a sensor cluster satisfied a threshold criterion (e.g., exceeded or fell below a threshold value), the correction action module 115 can perform one or more corrective action (e.g., increase power, decrease flowrate, etc.). The corrective actions can be stored in a fault pattern library on data store 140. In some embodiments, the corrective action module 115 receives an indication of a corrective action from the predictive system 160 and causes the corrective action to be implemented. Each client device 110 can include an operating system that allows users to one or more of generate, view, or edit data (e.g., indication associated with manufacturing equipment 124, corrective actions associated with manufacturing equipment 124, etc.).

Although shown as module of client device 110, each module 111-115 can be included in one or more other computing devices, such as a rackmount server, a router computer, a server computer, a personal computer, a mainframe computer, a laptop computer, a tablet computer, a desktop computer, a GPU, an ASIC, etc. Each module 111-115 can execute instructions to perform any one or more of the methodologies and/or embodiments described herein. The instructions can be stored on a computer readable storage medium, which can include the main memory, static memory, secondary storage and/or processing device (during execution of the instructions).

Data store 140 can be a memory (e.g., random access memory), a drive (e.g., a hard drive, a flash drive), a database system, or another type of component or device capable of storing data. Data store 140 can include multiple storage components (e.g., multiple drives or multiple databases) that can span multiple computing devices (e.g., multiple server computers). The data store 140 can store data associated with processing a substrate at manufacturing equipment 124. For example, data store 140 can store data collected by sensors 126 at manufacturing equipment 124 before, during, or after a substrate process (referred to as process data). Process data can refer to historical process data (e.g., process data generated for a prior substrate processed at the manufacturing system) and/or current process data (e.g., process data generated for a current substrate processed at the manufacturing system). Data store can also store spectral data or non-spectral data associated with a portion of a substrate processed at manufacturing equipment 124. Spectral data can include historical spectral data and/or current spectral data.

Data store 140 can also store contextual data associated with one or more substrates processed at the manufacturing system. Contextual data can include a recipe name, recipe step number, preventive maintenance indicator, operator, etc. Contextual data can refer to historical contextual data (e.g., contextual data associated with a prior process performed for a prior substrate) and/or current process data (e.g., contextual data associated with current process or a future process to be performed for a prior substrate). The contextual data can further include identify sensors that are associated with a particular sub-system of a process chamber.

Data store 140 can also store task data. Task data can include one or more sets of operations to be performed for the substrate during a deposition process and can include one or more settings associated with each operation. For example, task data for a deposition process can include a temperature setting for a process chamber, a pressure setting for a process chamber, a flow rate setting for a precursor for a material of a film deposited on a substrate, etc. In another example, task data can include controlling pressure at a defined pressure point for the flow value. Task data can refer to historical task data (e.g., task data associated with a prior process performed for a prior substrate) and/or current task data (e.g., task data associated with current process or a future process to be performed for a substrate).

In some embodiments, data store 140 can store statistics data. Statistics data can include statistics representative of the raw data, generated by SSM 112, e.g., mean data (average), range data, standard deviation data, maximum and minimum data, median data, mode data, etc. Mean data can include a measured averages of two or more values. For example, mean data can be used to determine the average heater temperature, the process chamber pressure, the average flowrate of a gas, etc., during a step(s), a specific time duration, an entire process recipe, etc. Range data can include the middle observation in a set of data (e.g., a median temperature during a step). Range data can include the difference between a maximum value and a minimum value of a set of values (e.g. the range of the heater pressure during a process recipe). The standard deviation is measure of the amount of variation or dispersion of a set of values.

In some embodiments, data store 140 can store sensor cluster data. Sensor cluster data can include data identifying to which cluster a sensor (or array) is assigned. For example, a first set of sensors or arrays can be assigned (by clustering module 113) to cluster A, a second set of sensors or arrays can be assigned to cluster B, etc. In some embodiments, the sensor cluster data can include metadata that is related to each particular sensor or array. In some embodiments, the sensor cluster data can include a data structure, such as a data table, which stores records, where each record include a sensor identifier or array and a cluster identifier.

In some embodiments, data store 140 can be configured to store data that is not accessible to a user of the manufacturing system. For example, process data, spectral data, contextual data, etc. obtained for a substrate being processed at the manufacturing system is not accessible to a user (e.g., an operator) of the manufacturing system. In some embodiments, all data stored at data store 140 can be inaccessible by the user of the manufacturing system. In other or similar embodiments, a portion of data stored at data store 140 can be inaccessible by the user while another portion of data stored at data store 140 can be accessible by the user. In some embodiments, one or more portions of data stored at data store 140 can be encrypted using an encryption mechanism that is unknown to the user (e.g., data is encrypted using a private encryption key). In other or similar embodiments, data store 140 can include multiple data stores where data that is inaccessible to the user is stored in one or more first data stores and data that is accessible to the user is stored in one or more second data stores.

In some embodiments, data store 140 can be configured to store data associated with known fault patterns. A fault pattern can be a one or more values (e.g., a vector, a scalar, etc.) associated with one or more issues or failures associated with a process chamber sub-system. In some embodiments, a fault pattern can be associated with a corrective action. For example, a fault pattern can include parameter adjustment steps to correct the issue or failure indicated by the fault pattern. For example, the predictive system or the corrective action module can compare a determined fault pattern (determined from data obtained from of one or more sensors of a sensor cluster) to a library of known fault patterns to determine the type of failure experienced by a sub-system, the cause of the failure, the recommended corrective action to correct the fault, and so forth.

The client device 110, manufacturing equipment 124, sensors 126, predictive system 160, and data store 140 can be coupled to each other via a network 130. In some embodiments, network 130 is a public network that provides client device 110 with access to predictive system 160, data store 140, manufacturing equipment 124 (not shown) and other publically available computing devices. In some embodiments, network 130 is a private network that provides client device 110 access to manufacturing equipment 124, data store 140, predictive system 160, and other privately available computing devices. Network 130 can include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In embodiments, a “user” can be represented as a single individual. However, other embodiments of the disclosure encompass a “user” being an entity controlled by a plurality of users and/or an automated source. For example, a set of individual users federated as a group of administrators can be considered a “user.”

FIG. 2 is a top schematic view of an example manufacturing system 200, according to aspects of the present disclosure. Manufacturing system 200 can perform one or more processes on a substrate 202. Substrate 202 can be any suitably rigid, fixed-dimension, planar article, such as, e.g., a silicon-containing disc or wafer, a patterned wafer, a glass plate, or the like, suitable for fabricating electronic devices or circuit components thereon.

Manufacturing system 200 can include a process tool 204 and a factory interface 206 coupled to process tool 204. Process tool 204 can include a housing 208 having a transfer chamber 210 therein. Transfer chamber 210 can include one or more process chambers (also referred to as processing chambers) 214, 216, 218 disposed therearound and coupled thereto. Process chambers 214, 216, 218 can be coupled to transfer chamber 210 through respective ports, such as slit valves or the like. Transfer chamber 210 can also include a transfer chamber robot 212 configured to transfer substrate 202 between process chambers 214, 216, 218, load lock 220, etc. Transfer chamber robot 212 can include one or multiple arms where each arm includes one or more end effectors at the end of each arm. The end effector can be configured to handle particular objects, such as wafers, sensor discs, sensor tools, etc.

Process chambers 214, 216, 218 can be adapted to carry out any number of processes on substrates 202. A same or different substrate process can take place in each processing chamber 214, 216, 218. A substrate process can include atomic layer deposition (ALD), physical vapor deposition (PVD), chemical vapor deposition (CVD), etching, annealing, curing, pre-cleaning, metal or metal oxide removal, or the like. Other processes can be carried out on substrates therein. Process chambers 214, 216, 218 can each include one or more sensors configured to capture data for substrate 202 before, after, or during a substrate process. For example, the one or more sensors can be configured to capture spectral data and/or non-spectral data for a portion of substrate 202 during a substrate process. In other or similar embodiments, the one or more sensors can be configured to capture data associated with the environment within process chamber 214, 216, 218 before, after, or during the substrate process. For example, the one or more sensors can be configured to capture data associated with a temperature, a pressure, a gas concentration, etc. of the environment within process chamber 214, 216, 218 during the substrate process.

In some embodiments, metrology equipment (not shown) can be located within the process tool. In other embodiments, metrology equipment (not shown) can be located within one or more process chambers 214, 216, 218. In some embodiments, the substrate can be placed onto metrology equipment using transfer chamber robot 212. In other embodiments, the metrology equipment can be part of the substrate support assembly (not shown). Metrology equipment can provide metrology data associated with substrates processed by manufacturing equipment 124. The metrology data can include a value of film property data (e.g., wafer spatial film properties), dimensions (e.g., thickness, height, etc.), dielectric constant, dopant concentration, density, defects, etc. In some embodiments, the metrology data can further include a value of one or more surface profile property data (e.g., an etch rate, an etch rate uniformity, a critical dimension of one or more features included on a surface of the substrate, a critical dimension uniformity across the surface of the substrate, an edge placement error, etc.). The metrology data can be of a finished or semi-finished product. The metrology data can be different for each substrate. Metrology data can be generated using, for example, reflectometry techniques, ellipsometry techniques, TEM techniques, and so forth.

A load lock 220 can also be coupled to housing 208 and transfer chamber 210. Load lock 220 can be configured to interface with, and be coupled to, transfer chamber 210 on one side and factory interface 206. Load lock 220 can have an environmentally-controlled atmosphere that can be changed from a vacuum environment (wherein substrates can be transferred to and from transfer chamber 210) to an at or near atmospheric-pressure inert-gas environment (wherein substrates can be transferred to and from factory interface 206) in some embodiments. Factory interface 206 can be any suitable enclosure, such as, e.g., an Equipment Front End Module (EFEM). Factory interface 206 can be configured to receive substrates 202 from substrate carriers 222 (e.g., Front Opening Unified Pods (FOUPs)) docked at various load ports 224 of factory interface 206. A factory interface robot 226 (shown dotted) can be configured to transfer substrates 202 between carriers (also referred to as containers) 222 and load lock 220. Carriers 222 can be a substrate storage carrier or a replacement part storage carrier.

Manufacturing system 200 can also be connected to a client device (e.g., client device 110, not shown) that is configured to provide information regarding manufacturing system 200 to a user (e.g., an operator). In some embodiments, the client device can provide information to a user of manufacturing system 200 via one or more graphical user interfaces (GUIs). For example, the client device can provide information regarding a target thickness profile for a film to be deposited on a surface of a substrate 202 during a deposition process performed at a process chamber 214, 216, 218 via a GUI. The client device can also provide information regarding anomaly detection and fault classification, in accordance with embodiments described herein.

Manufacturing system 200 can also include a system controller 228. System controller 228 can be and/or include a computing device such as a personal computer, a server computer, a programmable logic controller (PLC), a microcontroller, and so on. System controller 228 can include one or more processing devices, which can be general-purpose processing devices such as a microprocessor, central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device can also be one or more special-purpose processing devices such as an application specific integrated circuit (ASIC), a field programmable gate array (FPGA), a digital signal processor (DSP), network processor, or the like. System controller 228 can include a data storage device (e.g., one or more disk drives and/or solid state drives), a main memory, a static memory, a network interface, and/or other components. System controller 228 can execute instructions to perform any one or more of the methodologies and/or embodiments described herein. In some embodiments, system controller 228 can execute instructions to perform one or more operations at manufacturing system 200 in accordance with a process recipe. The instructions can be stored on a computer readable storage medium, which can include the main memory, static memory, secondary storage and/or processing device (during execution of the instructions).

System controller 228 can receive data from sensors (e.g., sensors 126, now shown) included on or within various portions of manufacturing system 200 (e.g., processing chambers 214, 216, 218, transfer chamber 210, load lock 220, etc.). In some embodiments, data received by the system controller 228 can include spectral data and/or non-spectral data for a portion of substrate 202. In other or similar embodiments, data received by the system controller 228 can include data associated with processing substrate 202 at processing chamber 214, 216, 218, as described previously. For purposes of the present description, system controller 228 is described as receiving data from sensors included within process chambers 214, 216, 218. However, system controller 228 can receive data from any portion of manufacturing system 200 and can use data received from the portion in accordance with embodiments described herein. In an illustrative example, system controller 228 can receive data from one or more sensors for process chamber 214, 216, 218 before, after, or during a substrate process at the process chamber 214, 216, 218. Data received from sensors of the various portions of manufacturing system 200 can be stored in a data store 250. Data store 250 can be included as a component within system controller 228 or can be a separate component from system controller 228. In some embodiments, data store 250 can be data store 140 described with respect to FIG. 1.

FIG. 3 depicts an illustrative predictive architecture 300, according to aspects of the present disclosure. In some embodiments, predictive architecture 300 include predictive system 160, network 130, and data store 310 (which can be similar to the same as data store 140). In some embodiments, predictive system 160 can use a model (e.g., model 190) to group two or more sensor based on, for example, sensor statistics data. For example, model 190 can received sensor statistics data as input, and generate, as output, sensor cluster data. In some embodiments, predictive system 160 can include predictive server 112, server machines 170 and 180, and predictive server 195. The predictive server 160, server machine 170, server machine 180, and predictive server 195 can each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

Server machine 170 includes a training set generator 172 that is capable of generating training data sets (e.g., a set of data inputs and a set of target outputs) to train, validate, and/or test a machine-learning model 190. Machine-learning model 190 can be any algorithmic model capable of learning from data. In some embodiments, machine-learning model 190 can be a predictive model. In some embodiments, the data set generator 172 can partition the training data into a training set, a validating set, and a testing set, which can be stored, as part of the training statistics 312, in the training data store 310. Training statistics 312 which can be accessible to the computing device predictive system 160 directly or via network 130. In some embodiments, the predictive system 160 generates multiple sets of training data.

Server machine 180 can include a training engine 182, a validation engine 184, a selection engine 185, and/or a testing engine 186. An engine can refer to hardware (e.g., circuitry, dedicated logic, programmable logic, microcode, processing device, etc.), software (such as instructions run on a processing device, a general purpose computer system, or a dedicated machine), firmware, microcode, or a combination thereof. Training engine 182 can be capable of training one or more machine-learning model 190. Machine-learning model 190 can refer to the model artifact that is created by the training engine 182 using the training data (also referred to herein as a training set) that includes training inputs and corresponding target outputs (correct answers for respective training inputs). The training engine 182 can find patterns in the training data that map the training input to the target output (the answer to be predicted), and provide the machine-learning model 190 that captures these patterns. The machine-learning model 190 can use one or more of a statistical modelling, support vector machine (SVM), Radial Basis Function (RBF), clustering, supervised machine-learning, semi-supervised machine-learning, unsupervised machine-learning, k-nearest neighbor algorithm (k-NN), linear regression, random forest, neural network (e.g., artificial neural network), etc.

One type of machine learning model that can be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities can be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks can learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In a plasma process tuning, for example, the raw input can be process result profiles (e.g., thickness profiles indicative of one or more thickness values across a surface of a substrate); the second layer can compose feature data associated with a status of one or more zones of controlled elements of a plasma process system (e.g., orientation of zones, plasma exposure duration, etc.); the third layer can include a starting recipe (e.g., a recipe used as a starting point for determining an updated process recipe the process a substrate to generate a process result the meets threshold criteria). Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs can be that of the network and can be the number of hidden layers plus one. For recurrent neural networks, in which a signal can propagate through a layer more than once, the CAP depth is potentially unlimited.

In one embodiment, one or more machine learning model is a recurrent neural network (RNN). An RNN is a type of neural network that includes a memory to enable the neural network to capture temporal dependencies. An RNN is able to learn input-output mappings that depend on both a current input and past inputs. The RNN will address past and future flow rate measurements and make predictions based on this continuous metrology information. RNNs can be trained using a training dataset to generate a fixed number of outputs (e.g., to determine a set of substrate processing rates, determine modification to a substrate process recipe). One type of RNN that can be used is a long short term memory (LSTM) neural network.

Training of a neural network can be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

A training dataset containing hundreds, thousands, tens of thousands, hundreds of thousands or more sensor data and/or process result data (e.g., metrology data such as one or more thickness profiles associated with the sensor data) can be used to form a training dataset.

To effectuate training, processing logic can input the training dataset(s) into one or more untrained machine learning models. Prior to inputting a first input into a machine learning model, the machine learning model can be initialized. Processing logic trains the untrained machine learning model(s) based on the training dataset(s) to generate one or more trained machine learning models that perform various operations as set forth above. Training can be performed by inputting one or more of the sensor data into the machine learning model one at a time.

The machine learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer can be another hidden layer or an output layer. In either case, the nodes at the next layer receive the output values from the nodes at the previous layer, and each node applies weights to those values and then generates its own output value. This can be performed at each layer. A final layer is the output layer, where there is one node for each class, prediction and/or output that the machine learning model can produce.

Accordingly, the output can include one or more predictions or inferences. For example, an output prediction or inference can include one or more predictions of film buildup on chamber components, erosion of chamber components, predicted failure of chamber components, and so on. Processing logic determines an error (i.e., a classification error) based on the differences between the output (e.g., predictions or inferences) of the machine learning model and target labels associated with the input training data. Processing logic adjusts weights of one or more nodes in the machine learning model based on the error. An error term or delta can be determined for each node in the artificial neural network. Based on this error, the artificial neural network adjusts one or more of its parameters for one or more of its nodes (the weights for one or more inputs of a node). Parameters can be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters can include adjusting the weights assigned to each of the inputs for one or more neurons at one or more layers in the artificial neural network.

After one or more rounds of training, processing logic can determine whether a stopping criterion has been met. A stopping criterion can be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy can be, for example, 70%, 80% or 90% accuracy. In one embodiment, the stopping criterion is met if accuracy of the machine learning model has stopped improving. If the stopping criterion has not been met, further training is performed. If the stopping criterion has been met, training can be complete. Once the machine learning model is trained, a reserved portion of the training dataset can be used to test the model.

Once one or more trained machine learning models 190 are generated, they can be stored in predictive server 195 as predictive component 197 or as a component of predictive component 197.

The validation engine 184 can be capable of validating machine-learning model 190 using a corresponding set of features of a validation set from training set generator 172. Once the model parameters have been optimized, model validation can be performed to determine whether the model has improved and to determine a current accuracy of the deep learning model. The validation engine 184 can determine an accuracy of machine-learning model 190 based on the corresponding sets of features of the validation set. The validation engine 184 can discard a trained machine-learning model 190 that has an accuracy that does not meet a threshold accuracy. In some embodiments, the selection engine 185 can be capable of selecting a trained machine-learning model 190 that has an accuracy that meets a threshold accuracy. In some embodiments, the selection engine 185 can be capable of selecting the trained machine-learning model 190 that has the highest accuracy of the trained machine-learning models 190.

The testing engine 186 can be capable of testing a trained machine-learning model 190 using a corresponding set of features of a testing set from data set generator 172. For example, a first trained machine-learning model 190 that was trained using a first set of features of the training set can be tested using the first set of features of the testing set. The testing engine 186 can determine a trained machine-learning model 190 that has the highest accuracy of all of the trained machine-learning models based on the testing sets.

As described in detail below, predictive server 195 includes a predictive component 197 that is capable of providing data indicative of sensor clustering, and running trained machine-learning model 190 on data items such as sensor data, statistics data, arrays, etc. input to obtain one or more outputs. The predictive server 195 can further provide sensor cluster data and/or anomaly detection data. This will be explained in further detail below.

It should be noted that in some other implementations, the functions of server machines 170 and 180, as well as predictive server 195, can be provided by a fewer number of machines. For example, in some embodiments, server machines 170 and 180 can be integrated into a single machine, while in some other or similar embodiments, server machines 170 and 180, as well as predictive server 195, can be integrated into a single machine.

In general, functions described in one implementation as being performed by server machine 170, server machine 180, and/or predictive server 195 can also be performed on client device 110. In addition, the functionality attributed to a particular component can be performed by different or multiple components operating together.

In some embodiments, a manufacturing system can include more than one process chambers. For example, example manufacturing system 200 of FIG. 2 illustrates multiple process chambers 214, 216, 218. It should be noted that, in some embodiments, data obtained to train the machine-learning model 190 and data collected to be provided as input to the machine-learning model can be associated with the same process chamber of the manufacturing system. In other or similar embodiments, data obtained to train the machine-learning model and data collected to be provided as input to the machine-learning model can be associated with different process chambers of the manufacturing system. In other or similar embodiments, data obtained to train the machine-learning model can be associated with a process chamber of a first manufacturing system and data collected to be provide as input to the machine-learning model can be associated with a process chamber of a second manufacturing system.

FIG. 4 is an exemplary illustration of a machine learning system 400 that is capable of anomaly detection based on aggregate statistics using neural networks, in accordance with some implementations of the present disclosure. As illustrated, the machine learning system 400 can include a client device 110, a training statistics repository, such as data store 310, and server machine 180 connected to network 130. Network 130 can be a public network (e.g., the Internet), a private network (e.g., a local area network (LAN) or wide area network (WAN)), or a combination thereof. Depicted in FIG. 4 is a set of sensor statistics 402 (which can be generated by SSM 112 based on raw data obtained by the SCM 111 from sensors 126) that can be processed by the ADM 114. The ADM 114 can include a number of components (implemented in software and hardware), such as pre-processing module 410, reducer neural network 420, one or more outlier detection models 430, normalization module 440, detector neural network 450, and other components not depicted explicitly in FIG. 4.

The pre-processing module 410 can remove artifacts that can be associated with preventive maintenance, intended changes in the settings of the manufacturing processes, changes in the settings of the system hardware, and the like, to produce the initial representation of sensor statistics. The initial representation of sensor statistics can be aggregated statistics for some or all the sensor data. The reducer neural network 420 (herein referred to as simply the “reducer 420”) can reduce the statistics prepared by the pre-processing 410 and transform the initial representation of the statistics to a different representation (referred herein as the reduced representation) that includes the most representative features of the statistics and has fewer elements (e.g., parameters) than the initial representation. The outlier detection models 430 can identify various (statistical) features present in the reduced representation of statistics. The identified statistical features can be cast in the form of outlier scores amenable to neural network processing. The normalization module 440 can normalize the inhomogeneous outputs (outlier scores) of various detection models to prepare the outputs for the neural network processing. The detector neural network 450 (herein sometimes referred to as the “detector 450”) can use the normalized features output by the outlier detection models 430 and predict the anomaly score for the manufacturing process.

The reducer 420 and/or the detector 450 can be trained by the server machine 180, which can include training engine 182. The training engine 182 can construct the machine learning models (e.g., neural networks 420 and 450), in some implementations. The neural networks 420 and 450 can be trained by the training engine 182 using training data that includes training inputs 462 and corresponding training (target) outputs 466. In some implementations, the reducer 420 and the detector 450 can be trained separately.

The training outputs 466 can include correct associations (mappings) of training inputs 462 to training outputs 466. The training engine 182 can find patterns in the training data that map the training input 462 to the training output 466 (e.g., the associations to be predicted), and train the reducer 420 and/or detector 450 to capture these patterns. The patterns can subsequently be used by the reducer 420 and/or detector 450 for future data processing and anomaly detection. For example, upon receiving a set of sensor statistics 402, the trained reducer 420 and/or detector 450 can be capable of identifying if the sensor statistics 402 are indicative of a manufacturing anomaly, such as one or more operations or products of the manufacturing equipment 124 deviating from the respective process recipes or product specifications.

Each of the neural networks 420 and 450 can include a single level of linear or non-linear neural operations, in various implementations. In some implementations, the neural networks 420 and 450 can be deep neural networks having multiple levels of linear or non-linear operations. Examples of deep neural networks are neural networks including convolutional neural networks, recurrent neural networks (RNN) with one or more hidden layers, fully connected neural networks, Boltzmann machines, and so on. In some implementations, the neural networks 420 and 450 can include multiple neurons wherein each neuron can receive its input from other neurons or from an external source and can produce an output by applying an activation function to the sum of weighted inputs and a trainable bias value. The neural networks 420 and 450 can include multiple neurons arranged in layers, including an input layer, one or more hidden layers, and an output layer. Neurons from adjacent layers can be connected by weighted edges. Initially, all the edge weights can be assigned some starting (e.g., random) values. For every training input 462 in the training dataset, the training engine 182 can cause the neural networks 420 and 450 to generate outputs (predicted anomaly scores for a set of training sensor statistics). The training engine 462 can compare the observed output of the neural networks 420 and 450 with the target training output 466. The resulting error, e.g., the difference between the target training output and the actual output of the neural networks, can be propagated back through the neural networks 420 and 450, and the weights and biases in the neural networks can be adjusted to make the actual outputs closer to the training outputs. This adjustment can be repeated until the output error for a particular training input 462 satisfies a predetermined condition (e.g., falls below a predetermined value). Subsequently, a different training input 462 can be selected, a new output generated, a new series of adjustments implemented, until the neural networks are trained to an acceptable degree of accuracy.

The training inputs 462, the training outputs 466, and the mapping data 464 can be stored, as part of the training statistics 312, in the data store 310, which can be accessible to the client device 110 directly or via network 130. The training statistics 312 can be actual, e.g., past statistics of sensors 126 of the manufacturing equipment 124 or a similar type machine (e.g. one or more machine used by a developer to train the neural networks 420 and 450). The training statistics 312 can include a wide variety of statistics representative of an occurrence (or non-occurrence) of a particular manufacturing anomaly, such as incorrect temperature, pressure, chemical compositions regimes, deficient (or normal) film, wafer, or any other product of the manufacturing equipment 124 (or a similar machine). The training statistics 312 can include examples of anomalies present in the manufacturing process to various degrees, such as a significant anomaly that results in a sub-standard yield, a correctable anomaly that can be eliminated with timely and appropriate counter-measures, an insignificant anomaly that is unlikely to affect the quality of the manufacturing output, and so on. In some implementations, the presence of the anomaly in the training statistics 312 can be indicated by a continuous or quasi-continuous anomaly score (e.g., a value within the 0.0 to 1.0 range, or 0 to 100 range, or any other range). Anomaly score in the training statistics 312 can be a part of the training output 466.

The data store 310 can be a persistent storage capable of storing sensor data or sensor data statistics as well as metadata for the stored data/statistics. The data store 310 can be hosted by one or more storage devices, such as main memory, magnetic or optical storage based disks, tapes or hard drives, NAS, SAN, and so forth. Although depicted as separate from the client device 110, in some implementations the data store 310 can be a part of the client device 110. In some implementations, the data store 310 can be a network-attached file server, while in other implementations the data store 310 can be some other type of persistent storage, such as an object-oriented database, a relational database, and so forth, that can be hosted by a server machine or one or more different machines coupled to the client device 110 via the network 130.

Once the neural networks 420 and 450 are trained, the trained neural networks can be provided to the ADM 114 for processing of new sensor statistics. For example, the ADM 114 can receive a new set of sensor statistics 402, pass it through some or all of the components of the ADM 114, e.g., pre-processing 410, reducer 420, one or more outlier detection models 430, normalization module 440, and detector network 550 to predict an anomaly score representative of a likelihood that the sensor statistics 402 is indicative of a manufacturing anomaly.

“Processing device” herein refers to a device capable of executing instructions encoding arithmetic, logical, or I/O operations. In one illustrative example, a processing device can follow Von Neumann architectural model and can include an arithmetic logic unit (ALU), a control unit, and a plurality of registers. In a further aspect, a processing device can be a single core processor, which is typically capable of executing one instruction at a time (or process a single pipeline of instructions), or a multi-core processor which can simultaneously execute multiple instructions. In another aspect, a processing device can be implemented as a single integrated circuit, two or more integrated circuits, or can be a component of a multi-chip module. A processing device can also be referred to as a CPU. “Memory device” herein refers to a volatile or non-volatile memory, such as random-access memory (RAM), read-only memory (ROM), electrically erasable programmable read-only memory (EEPROM), or any other device capable of storing data.

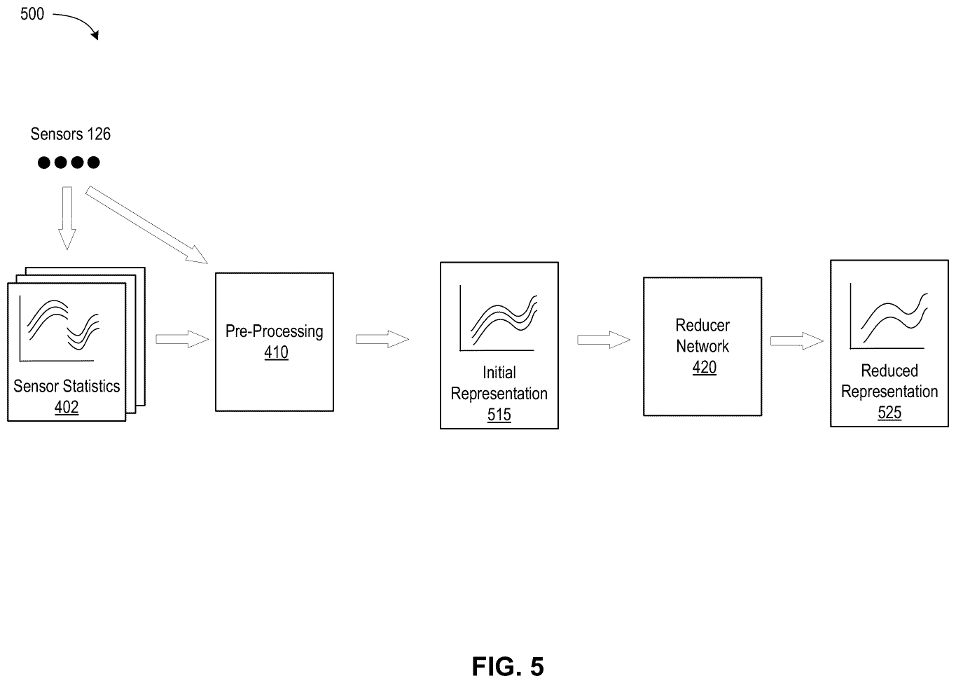

FIG. 5 is an exemplary illustration of a reduction stage 500 of anomaly detection based on aggregate statistics using neural networks, in accordance with some implementations of the present disclosure. Depicted in FIG. 5 is a set of sensor statistics 402 which can be derived from sensors 126 via one or more intermediate operations. For example, the SCM 111 can identify a time horizon (e.g., 30 seconds, three minutes, etc.), which can be a full duration of a particular (e.g., ongoing or about to start) manufacturing operation or a selected time interval that is less (or more) than the full duration of the operation. The SCM 111 can further identify which sensors 126 can be activated (or sampled) for the anomaly detection during the current operation for the duration of the identified time horizon. The SCM 111 can collect M sets of data (e.g., data from M sensors) each set including N readings. The number of readings, which can be controlled by varying a data sampling rate, can be sensor-specific. In some implementations, the time horizon can also be sensor-specific, so that sensor 1 can provide N₁ readings over time T₁ whereas sensor 2 can provide N₂ readings over time T₂. Accordingly, the SCM 111 can collect multiple sets of data points {Rⱼ}, wherein index j denotes a set of data points for the j-th sensor 1≤j≤M. Each set of data points can include a time series, {Rⱼ}=Rⱼ(t₁), Rⱼ(t₂), . . . Rⱼ(t_{N}), of data readings. Based on the raw sensor data sampled by the SCM 111, the SSM 112 can conduct statistical analysis of each of the obtained datasets {Rⱼ}, to determine a set of statistical parameters {Pⱼ}=Pⱼ(1), Pⱼ(2), . . . Pⱼ(S) that describe the respective dataset. The set of statistical parameters is referred to as “sensor statistics” (e.g., sensor statistics 402) in the instant disclosure. For example, Pⱼ(1) can be a mean value of the j-th dataset, Pⱼ(2) can be a median value of the same dataset, Pⱼ(3) can be a mode, Pⱼ(4) can be a standard deviation, Pⱼ(4) can be a half-width, Pⱼ(5) can be a lower bound (minimum value), Pⱼ(6) can be an upper bound (maximum value), Pⱼ (7) can be a skewness, Pⱼ(8) can be a kurtosis, and so on.

The sensor statistics 402 (e.g., sets of parameters {Pⱼ}) can be input into the pre-processing module 410, to filter out or otherwise account for various artifacts in the sensor data. In some implementations, the raw data (e.g., datasets {Rⱼ}) from sensors 126 can also be provided to the pre-processing module 410. Some of the features of the sensor statistics 402 can be representative of the anomalies of the manufacturing process, which are intended to be detected. Some of the features of the sensor statistics 402, however, can be indicative of various events that are not representative of any actual problems or deficiencies of the manufacturing processes, but could otherwise be detected as problematic, if the existence of such events is not properly taken into account. For example, the manufacturing equipment 124 might have undergone a maintenance (preventive, scheduled, or unplanned) procedure. During the maintenance procedure, one or more sensors 126 might have been exposed to a changed environment. Because sensors 126 are often miniature devices, the settings of the sensors (e.g., zero points) can change, as a result of such exposure. The sensor data can, therefore, shift substantially but such shifts can not be representative of any manufacturing process anomalies. In some implementations, the shifts in the sensor statistics 402 can be indicative of intentional changes to the manufacturing process. For example, an operator (e.g., user) of the manufacturing equipment 124 can change a set point of one or more conditions inside the processing chamber 214, 216, 218, such as a change in temperature, gas flow rate, chemical composition or concentration of the gas delivered into the processing chamber 214, 216, 218. In some implementations, a change in the sensor statistics 402 can be triggered by a change in the settings of one or more hardware devices in the processing chamber, such as a replacement of a process kit (e.g., an edge ring or the like).

In such instances, the client device 110 can detect an occurrence of an artifact event (maintenance, change in process set points, changes in the hardware settings, etc.) and notify the SCM 111 about the event. The SSM 112 can receive an indication of the event (e.g., a robot blade removing an old edge ring and delivering a new edge ring (at a specified time) into the processing chamber 214, 216, 218. The SSM 112 can correlated the changes in the sensor statistics 402 in the time interval following the artifact event and adjust the statistics 202 to remove (or compensate for) the changes in the sensor statistics caused by the artifact event. For example, the SSM 112 can determine a new mean of the distribution of the affected sensors (which could be any sensors whose readings have shifted at or after the artifact event) and recalculate the sensor statistics based on the new mean. In some implementations, the pre-processing module 410 can remove outliers, invalid values (such as Not-a-Number values) or, conversely, impute (add) missing values. The sensor statistics corrected in the described (or a similar) way can be output by the pre-processing module 410 in the form of the sets of adjusted parameters {Pⱼ} reflecting the corrected (adjusted to compensate for the influence of the artifact events) sensor statistics 402. The adjusted parameters {Pⱼ} can constitute a representation of the sensor statistics that is referred to in the instant disclosure as the initial representation 515 of the sensor statistics (even though the representation 515 can not be the earliest representation of the statistics generated by the SSM 112).

The initial representation 515 can be aggregated across some or all of the sensor statistics. Because different sensors statistics can be related to different quantities, including quantities measured in different units (e.g., temperature, pressure, gas flow, wafer thickness, reflectivity of the wafer surface, etc.), the sensor statistics can be normalized prior to aggregation. For example, the variance can first be expressed in units of the mean value squared whereas the third moment or cumulant (e.g., skewness) can be expressed in units of the mean cubed, and so on.

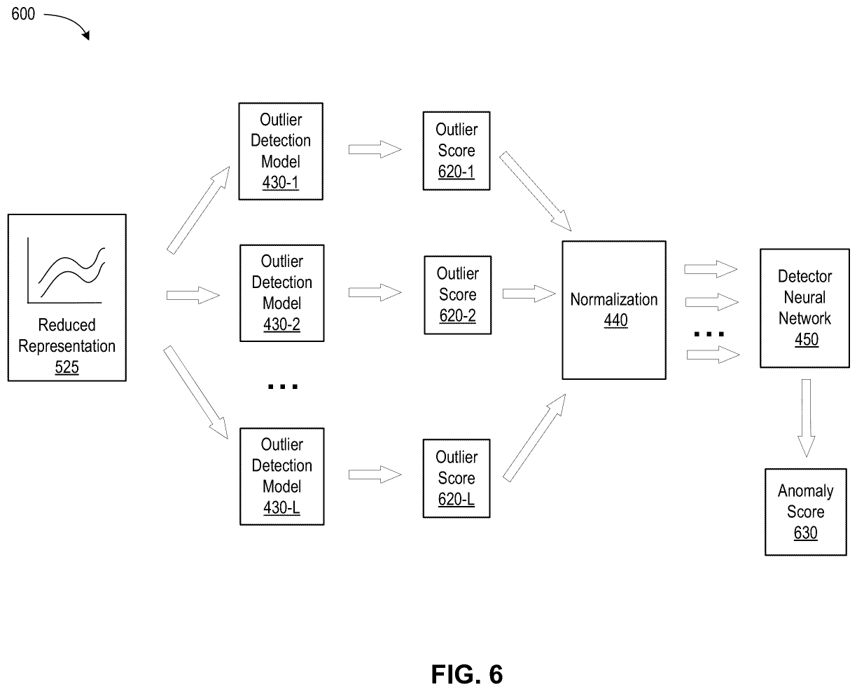

In some implementations, the initial representation 515 can be processed by the reducer neural network 420 to obtain a reduced representation 525 of the sensor statistics. The input to the reducer 420 can be an aggregated set of initial representations 515 of the sensor statistics. The initial representations 515 can contain a large amount of information only a fraction of which can be representative of a manufacturing anomaly. Accordingly, the function of the reducer 420 can be two-fold: to improve signal-to-noise ratio by distilling the initial representation 515 to the most representative features of the data statistics and to reduce the number of parameters describing the sensor statistics to a set that is more manageable and more amenable to further processing. The reducer neural network 420 can be an auto-encoder, in one implementation. In another implementation, the reducer neural network 420 can be an extreme learning machine. The reducer neural network 420 can be trained to output a reduced representation 525 having a number of dimensions that is lower (in some implementations, significantly lower) than the initial representation. For example, the reducer neural network 420 can use one of algorithms based on the Principal Component Analysis (PCA) to identify the most significant and representative (for the subsequent anomaly detection) features of the initial representation. In particular, PCA algorithms can find a transformation of the coordinate space of the initial representation 515 along which the variance of data points is maximized (principal axes) and select a certain number (determined and optimized during training) of the maximum variance axes, e.g., D). For each of the axes, the output can include one or more statistical parameters (mean, variance, etc.) for each of the principal axes, and a number of covariance parameters characterizing cross-correlations among statistical parameters relating to various axes. The advantage of using the reducer neural network 420 is that it allows to reduce the number of sensor statistics from, potentially, thousands of parameters to only a few (e.g., five, ten, twenty, and so on) key components, which represent critical variation of the sensor data and, at the same, time reduce noise. The use of the reducer 420 increase efficacy of the subsequent anomaly detection algorithms (as described in relation to FIG. 6). In some implementations, the reducer 420 can process all or some initial representations 515 of the sensor statistics concurrently.

FIG. 6 is an exemplary illustration of a detection stage 600 of anomaly detection based on aggregate statistics using neural networks, in accordance with some implementations of the present disclosure. Depicted in FIG. 6 is the reduced representation 525 of the sensor statistics being input into a set of the outlier detection models 430 (e.g. models 430-1, 430-2 . . . 430-L). Some or all of the outlier detection models 430 can employ a variety of algorithms, such as k-nearest neighbor outlier detection algorithms, clustering-based algorithms, mixture-based algorithms (e.g., a Cluster-Based Local Outlier Factor algorithm), embedding-based algorithms, decision-tree algorithms, support vector machine-based algorithms, histogram-based outlier score algorithms, principle component analysis algorithms, local outlier factor algorithms, local distance-based outlier detection algorithms, local outlier integral algorithms, and the like.

Each of the outlier detection models 430 applied to the reduced representation 525 can output a respective outlier score 620 indicative of the presence of various anomalies in the sensor statistics, according to the criteria of the respective outlier detection model 430. The outlier scores 620, being determined by different algorithms, can have values that are difficult to compare to each other directly. To make the outlier scores 620 better suited for subsequent uniform processing, the outlier scores 620 can be normalized by the normalization module 440. In some implementations, the normalization module 440 can perform a rescaling of the outlier scores 620. For example, if the maximum outlier value (e.g., a maximum value for a set of training sensor statistics, or a set of the actual run-time sensor statistics, or a combination thereof) is Oₘₐₓ and the minimum outlier value is Oₘᵢₙ, the normalized outlier score can be determined as

$${O}_{n o r m} = \frac{O - {O}_{min}}{{O}_{max} - {O}_{min}} .$$

The uniform normalization brings all outlier scores to within the interval of values [0,1], but does not account for the fact that the outlier scores O can be distributed non-uniformly within the interval [Oₘᵢₙ, Oₘₐₓ]. In some implementations, it can be difficult to predict what minimum or maximum outlier scores can be encountered in actual processing, so that other methods, e.g., as described below, can be used instead.

Accordingly, in some implementations, the normalization can instead be performed using an assumption (an approximation or a hypothesis) of some underlying distribution of the outlier scores O. For example, accounting for a Gaussian distribution of the outlier scores can be performed by determining the normalized outlier score according to the formula

$${O}_{n o r m} = max \{ O , Erf ( \frac{O - {O}_{m e a n}}{σ √ 2} ) \} ,$$

where Oₘₑₐₙ is the mean outlier score and σ is the standard deviation for the outlier scores (e.g., the mean value for a set of training sensor statistics, or a set of the actual sensor statistics, or a combination thereof), and Erƒ is the Gauss error function.

In some implementations, the normalization can be performed using the assumption of a Gamma distribution of the outlier scores according to the following formula

$${O}_{n o r m} = max \{ O , \frac{F ( O ) - F ( {O}_{m e a n} )}{1 - F ( {O}_{m e a n} )} \} ,$$

where F(O) is the cumulative distribution function for the Gamma distribution, e.g.,

$$F ( O ) = \frac{γ ( \frac{{O}_{m e a n}^{2}}{{σ}^{2}} , O \cdot \frac{{O}_{m e a n}^{2}}{{σ}^{2}} )}{Γ ( \frac{{O}_{m e a n}^{2}}{{σ}^{2}} )} ,$$

with Γ(x) being the Gamma function and γ(x,y) being the incomplete Gamma function.

The above non-limiting examples are intended as illustrations only. In various implementations, different underlying distributions can be used and the respective distribution-based normalization schemes can be different. In some implementations, a mixture of two or more probability distributions can be used to normalize the outlier scores 420.

The normalized outlier scores Oₙₒᵣₘ₋₁, Oₙₒᵣₘ₋₂, . . . O_{norm-L} obtained from all (or some of) the L outlier detection models 430 can be used as an input into the neural network detector 450 (“detector”) to determine the anomaly score. The detector 450 can be trained on a variety of training sensor statistics 310 using methods of deep learning. The detector 450 can be a Boltzmann machine, a convolutional neural network, a recurrent neural network, a fully connected neural network, or some other type of deep learning neural networks. The output of the detector 450 can be an anomaly score 630 indicating a likelihood that an anomaly is present in the input set of sensor statistics 402.

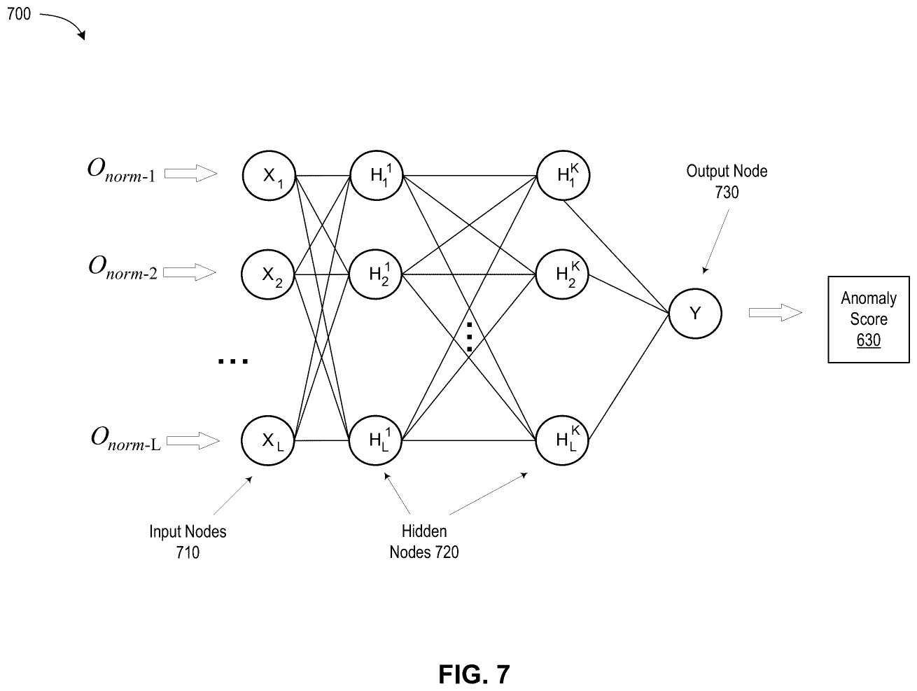

FIG. 7 is an exemplary neural network 700 that operates as a detector neural network 450 used in the detection stage of anomaly detection based on aggregate statistics using neural networks, in accordance with some implementations of the present disclosure. Depicted in FIG. 7 are the normalized outlier scores Oₙₒᵣₘ₋₁, Oₙₒᵣₘ₋₂, . . . O_{norm-L} input into a plurality of input nodes (neurons) Xⱼ 710-1, 710-2 . . . 710-L) of the detector 450. In some implementations, the neural network 500 can be a restricted Boltzmann machine (RBM). The input normalized outlier scores can be processed by one or more hidden layers having hidden nodes (neurons) 720. Each hidden node 720 can be associated with a hidden variable Hⱼ^{k}. Connections between adjacent columns of the RBM can have associated weights described by a weight matrix Wₗₘ having a value corresponding to a connection between l-th node of one layer with the m-th node of the adjacent layer. In the implementation depicted in FIG. 7, the weight matrix between the input and hidden layers are square matrices (since the number of nodes in each layer is L), but in other implementations, the number of nodes in each consecutive layer can be different from the number of nodes in the previous layer. Additionally, each layer can be associated with a set (vector, column) of biases b₁, b₂, . . . .

The RBM can be described by the “energy” symbolically written in the form,

E({Xⱼ},{Hⱼ^{k}})=−\hat{b}·\hat{ξ}−\hat{ξ}·Ŵ·\hat{ξ},

where \hat{ξ} denotes the vectors of variables (input X or hidden H) in various layers of the RGB, \hat{b} denotes the biases associated with the corresponding variables (nodes), and Ŵ stands for the weight matrices between the layers. The energy determines the probability of the configuration {Xⱼ},{Hⱼ^{k}}} according to the Boltzmann distribution,

P({Xⱼ},{Hⱼ^{k}})=Z⁻¹ exp(−E({Xⱼ},{Hⱼ^{k}})),

where Z is the partition function (normalization coefficient). Training of a two-layer RBM can be performed using training input vectors (outlier scores) where (1) the hidden variables are statistically determined from the input outlier scores, and (2) the hidden variables are used to reversely predict the value of the input nodes (this (1)+(2) procedure can be repeated a pre-set number of times) before the reversely-predicted input variables are compared to the actual input variables and the biases and weights of the RBM are adjusted until the two sets of the input variables are sufficiently close to each other (e.g., less than a pre-determined accuracy threshold).

In a deep learning RGB with multiple hidden layers, as depicted in FIG. 7, for example, a hidden layer is an input into the successive hidden layer. In some implementations, the hidden layers of the RGB are trained one at a time, e.g., from left to right, in a layer-wise fashion. Specifically, the hidden variables H₁², H₂² . . . H_{L}² are determined from the values H₁¹, H₂¹ . . . H_{L}¹, and so on. Such RGB architecture can be capable of disentangling factors of variation in the inputs. Namely, with the propagation through the RGB the hidden nodes can become less statistically dependent. Propagation of the data through the RGB can, therefore, reduce the conditional dependence of the nodes while preserving most of the information about the anomaly score that is output by the output node Y 730. The output node 730 can be viewed as a single-node hidden layer whose weights and a bias can be determined using the same procedures as described in relation to the hidden nodes 720.

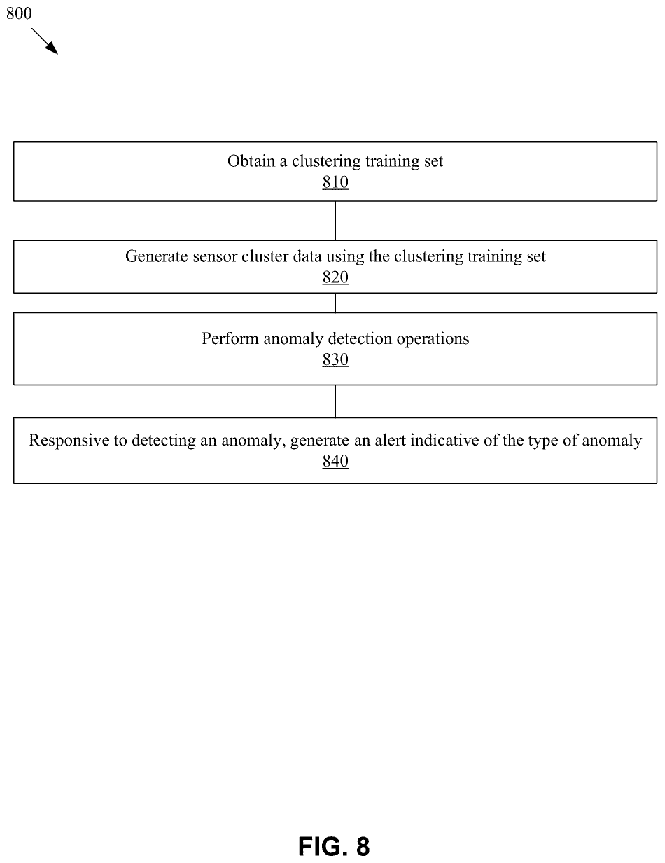

FIG. 8 is a flow chart of a method 800 for generating sensor cluster data, according to aspects of the present disclosure. Method 800 is performed by processing logic that can include hardware (circuitry, dedicated logic, etc.), software (such as is run on a general purpose computer system or a dedicated machine), firmware, or some combination thereof. In one implementation, method 800 can be performed by a computer system, such as computer system architecture 100 of FIG. 1. In other or similar implementations, one or more operations of method 800 can be performed by one or more other machines not depicted in the figures. In some aspects, one or more operations of method 800 can be performed by client device 120, server machine 170, server machine 180, and/or predictive server 112.

At operation 810, processing logic obtains a clustering training set. In particular, each run of a process recipe on a substrate can generate a collection of data items, referred to as a “process run dataset” (e.g., sensor data, statistics data, task data, contextual data, etc.). The clustering training set can include process run dataset from multiple process runs on a set of substrates. For example, the clustering training set can include 100 process run datasets, each dataset include a collection of data items from the execution of a process recipe on each substrate the set of substrates. In some embodiments, each clustering training set can include a set of arrays generated from the data items. An array can include a combination of data items according a predefined format or pattern (e.g., step.sensor.statistic).

In some embodiments, prior to being added to the clustering training set, the processing logic can first determine, via anomaly detection module 114, whether each process run dataset contains one or more anomalies (or a predetermined amount of anomalies). Responsive to a process run dataset including a predetermined set of anomalies, the processing logic can discard the defective process run dataset (e.g., exclude the anomalous process run dataset from the clustering training set. This can ensure that the clustering training set only include anomaly free data.

In some embodiments, the process run datasets of the clustering training set can be preselected or predetermined. For example, an operator (user) can select which process run datasets are to be include in the clustering training set. In some embodiments, the process runs datasets can be selected on a rolling basis. In particular, for example, a first initial set of process run datasets can be selected (e.g., the first 100 datasets generated by a particular process chamber, by manufacturing equipment 124, etc.). As new datasets are generated (e.g., new process runs are executed), each oldest process run data set in the clustering training set can be replaced with each new process run dataset generated.

At operation 820, the processing logic generates sensor cluster data using the clustering training set. In particular the processing logic can group the data items or arrays of the clustering data set into particular clusters. In some embodiments, the processing logic (via clustering module 113) can use one or more correlation methods to determine which data items or arrays exhibit a strong relationship (e.g., a relationship that satisfied a threshold criterion, such as a value representative of the relationship exceeding a threshold criterion). Data items or arrays that exhibit a strong relationship can be grouped into the same cluster. In an illustrative example, the processing logic can generate a Pearson correlation coefficient for two particular arrays using their corresponding data from each process run of the clustering training set. Responsive to the Pearson correlation coefficient satisfying a threshold criterion, (e.g., exceeding a threshold value), the processing logic can assign (e.g., label) both arrays to the same cluster. The sensor cluster data can be stored on, for example, a data store and can include a set of records where each record indicates a particular data item or array and the corresponding cluster ID.

In some embodiments, the processing logic can use a machine-learning model to generate the cluster data. For example, the processing logic can input the clustering training set in machine learning model 190, and receive, as output, predictive data indicative of which data items or arrays are correlated and/or predictive data indicative of cluster ID data for each data item or array.

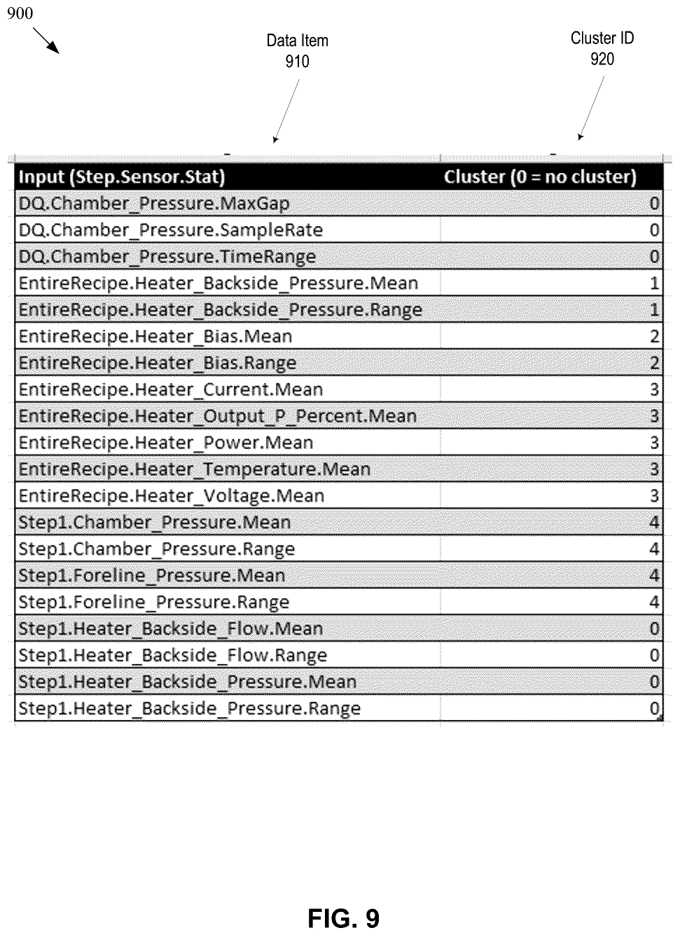

FIG. 9 is a data table illustrating a set of arrays and their corresponding cluster identifier, in accordance with some implementations of the present disclosure. In particular, table 900 illustrates a set of records. Each record include an array 910 and a corresponding cluster identifier (ID) 920. For example, the array indicative of a mean value for the chamber pressure of step 1 of a process recipe can be assigned to cluster 4. In some embodiments, cluster 0 indicates that the corresponding data item is not assigned to a cluster. Table 900 can be any type of data structure, such as, for example, a metadata table.

Returning to FIG. 8, at operation 830, the processing logic performs anomaly detection operations. In some embodiments, the processing logic can perform anomaly detection operations (via ADM 114) on real-time data or near-real time data received from SCM 111 and/or SSM 112. In some embodiments, the processing logic can perform the anomaly detection operations on a stored set of data (e.g., historical data from completed process runs).

At operation 840, responsive to detecting an anomaly, the processing logic generates an alert indicative of the type of anomaly. In some embodiments, the processing logic can determine, based on the sensor cluster data of the sensor(s) that generated an anomaly score that satisfied a threshold criterion, whether the manufacturing fault occurred for an entire cluster, a part of the cluster, for a single sensor, for a set of unrelated sensors, etc. For example, responsive to the processing logic detecting that three sensors outputted values that were determined to be anomalous, the processing logic can determine the cluster identifier associated with the three sensors. Based on the cluster identifier(s) of the three sensors, the processing logic can determine whether the manufacturing fault is related to a sub-system (e.g., when all three sensors are part of the same cluster) or with a component (e.g., when the three sensors are not part of the same cluster).

In some embodiments, responsive to detecting an anomaly, the processing logic can analyze the anomaly (e.g., analyze the anomaly score) and take (or abstain from taking), via the corrective action module 115, one or more remediation or corrective actions. Specifically, if the anomaly score is below a certain predetermined threshold, the processing logic may take no remediation action and/or, optionally, provide the anomaly score to the user (engineer, or any other operator of the manufacturing process). In those instances, where the anomaly score is above the threshold, the processing logic may initiate one or more remediation actions. For example, the processing logic may alert the user and advice the user of various corrective options, such as changing parameters of the manufacturing process, pausing the manufacturing process (e.g., for a quick maintenance), stopping the manufacturing process (e.g., for more extensive repairs), or the like. In some implementations, the processing device can take multiple remediation actions, e.g., adjust settings of the manufacturing process, schedule maintenance, and alert the user. In particular, the processing logic can generate a corrective action or updated a process recipe, based on the anomaly score of one or more sensors, by adjusting the parameters associated with the manufacturing process or values associated with the process recipe. For example, a correction profile have one or more adjustments can be applied to one or more steps of the current deposition process or a process recipe. This can be performed in response to user input, or automatically based on one or more predefined conditions (e.g., a sensor value satisfying a threshold criterion, such as a threshold value). Thus, the processing logic can perform, on the substrate, a subsequent step of the process recipe according to the updated process recipe. In some embodiments, the subsequent step comprises another deposition step, another etch step, etc. In some embodiments, the update process recipe can be used to perform additional deposition steps, additional etch steps, etc. on the substrate. Accordingly, the manufacturing process recipe can be adjusted in real or near real-time.

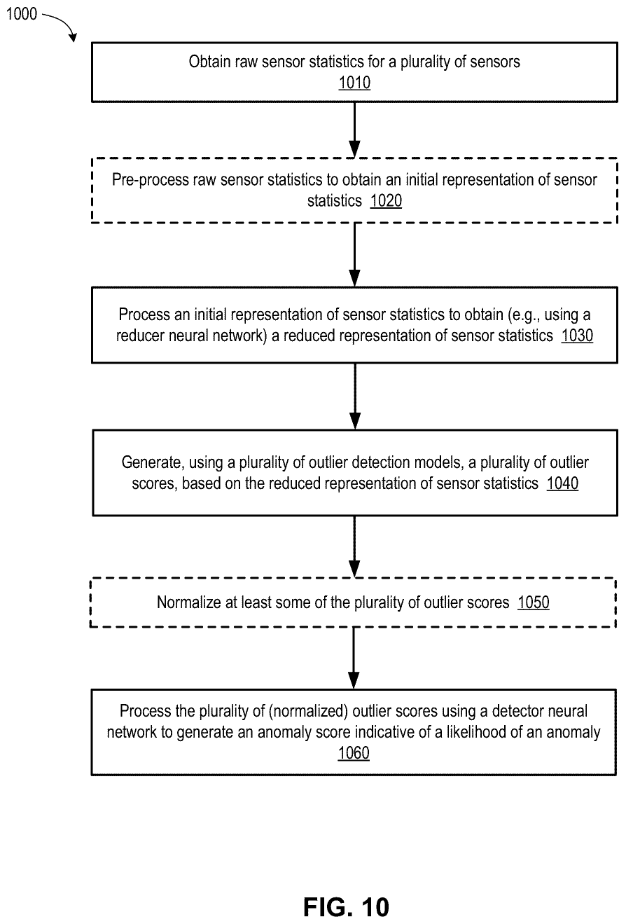

FIG. 10 is a flow chart of a method 1000 of anomaly detection based on aggregate statistics, according to aspects of the present disclosure. Method 1000 is performed by processing logic that can include hardware (circuitry, dedicated logic, etc.), software (such as is run on a general purpose computer system or a dedicated machine), firmware, or some combination thereof. In one implementation, method 1000 can be performed by a computer system, such as computer system architecture 100 of FIG. 1. In other or similar implementations, one or more operations of method 1000 can be performed by one or more other machines not depicted in the figures. In some aspects, one or more operations of method 800 can be performed by client device 120, server machine 170, server machine 180, and/or predictive server 112. In some embodiments, method 1000 can be related to the anomaly detection operations performed at operation 830 of FIG. 8.

Method 1000 will be discussed in relation to performing anomaly detection using a neural network. However, it should be understood that other methods discussed herein can be used for anomaly detection.

At operation 1010, processing logic obtains raw sensor statistics for a plurality of sensors (e.g., sensors 126) collecting data during the duration of the processing operation(s) (e.g., a process run) subject to anomaly detection. The set of sensors activated (or collecting data) during the processing operation(s) can be selected by the processing device based on the specifics of the processing operation(s). The raw sensor statistics can characterize a plurality of measurements associated with the activated (sampled) sensors. The statistics describing measurements collected by each or some of the sensors can include various parameters, such as a median, a mode, a variance, a standard deviation, a range, a maximum, a minimum, a skewness, or a kurtosis.

At operation 1020, processing logic pre-processes raw sensor statistics for each or some of the plurality of sensors. Pre-processing can involve adjusting the raw sensor statistics in view of various preventive maintenance events, such as changes of settings of the manufacturing operation, or changes in settings of the device manufacturing system. The output of the pre-processing can be an initial representation of the sensor statistics. The initial representation can be an aggregate representation of the sensor statistics.

At operation 1030, processing logic obtains a reduced representation of the sensor statistics reflective of the data collected by the sensors. In some implementations, the reduced representation of the sensor statistics can be obtained by processing the initial representation of the plurality of sensor statistics using a reducer neural network. In some implementations, the reducer neural network can be a feed-forward neural network. The reduced representation can have fewer parameters than the initial representation.

At operation 1040, processing logic generates a plurality of outlier scores. Each of the plurality of the outlier scores can be obtained by executing a respective outlier detection model. The input into the outlier detection models can be the reduced representation of the sensor statistics.

At block 1050, processing logic normalizes at least some of the outlier scores.

At block 1060, processing logic processes the plurality of normalized outlier scores using a detector neural network. The detector neural network can be a reduced Boltzmann machine network. In some implementations, the reduced Boltzmann machine network has two or more hidden layers to generate an anomaly score indicative of a likelihood of an anomaly associated with the manufacturing operation.

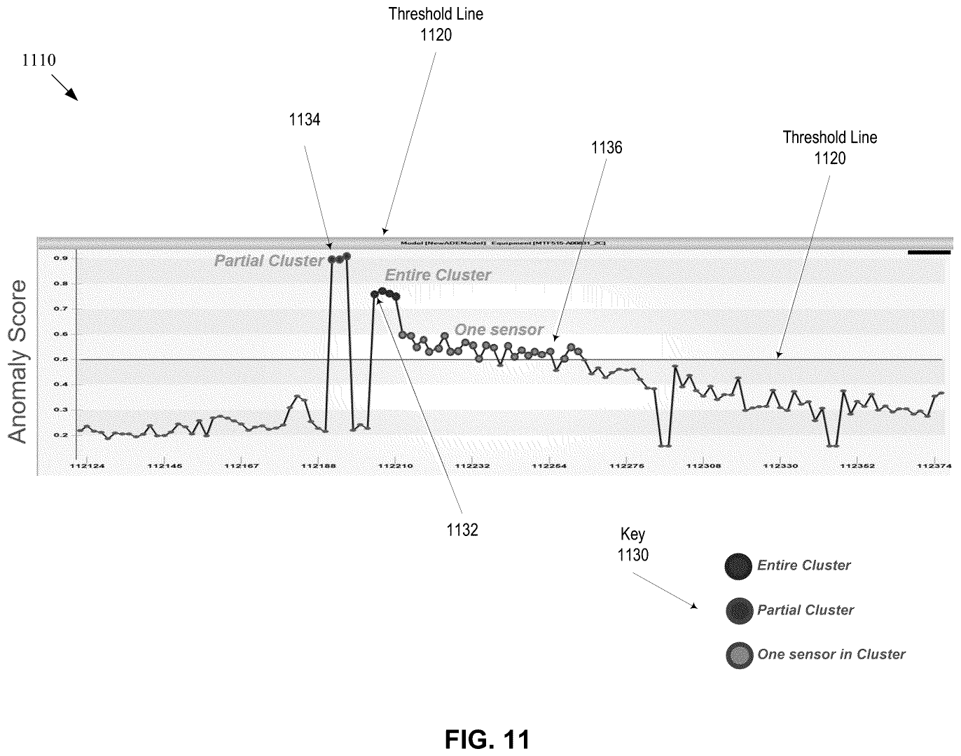

FIG. 11 is a graph 1110 showing output data, for a particular cluster, generated by the ADM 114, according to aspects of the present disclosure. In particular, each point on graph 1110 is indicative of a total anomaly score (y-axis) generated during a time period of a process run (e.g., execution of a recipe on a substrate). This total anomaly score, in this illustrative example, is representative of the statistics data of three sensors assigned to the same cluster (e.g., a heater power sensor, a heater voltage sensor, and a heater output sensor. As shown, responsive to the total anomaly score for a particular time period exceeding the threshold line 1120 (which correlates to a particular anomaly score value), the GUI of the client device can indicate that a possible issue occurred. In particular, the GUI can, based on whether the respective anomaly score of each of the individual sensors satisfies a threshold criterion, visually display (as indicated by key 1130) whether the detected anomaly is related to an entire cluster (e.g., sensor data or statistics data from each of the three sensors of the particular cluster satisfies a threshold criterion), a portion of the cluster (e.g., sensor data or statistics data from two of the three sensors of the particular cluster satisfy a threshold criterion), or a single sensor in a cluster (e.g., sensor data or statistics data from one of the three sensors of the particular cluster satisfies the threshold criterion). The threshold criterion can be an output value of a sensor exceeding of falling below one or more threshold values indicative of a deviation from the expected output value.

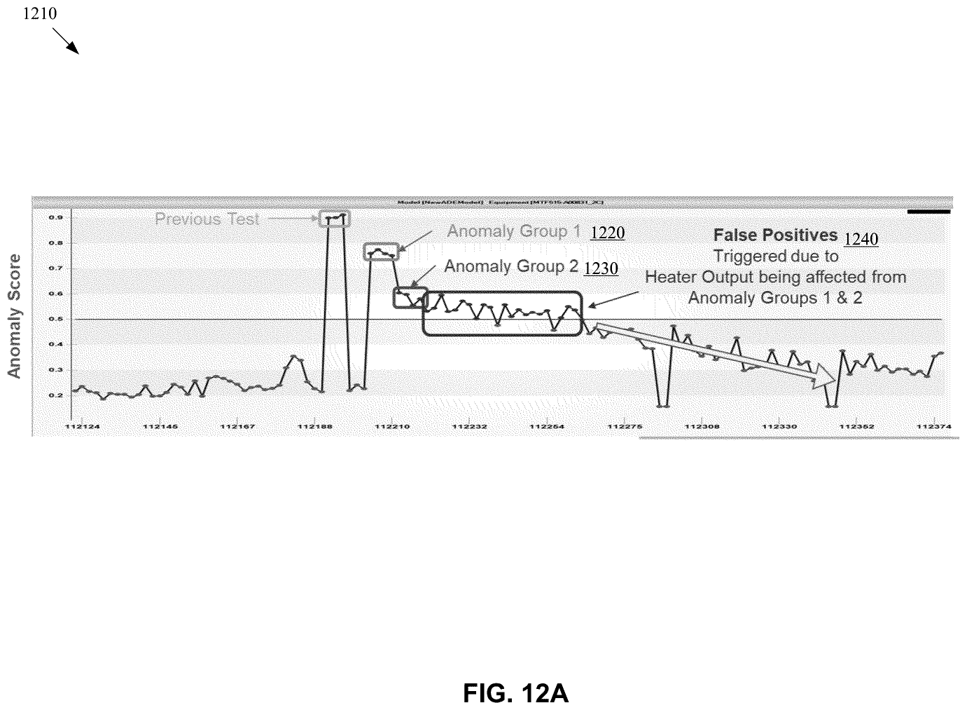

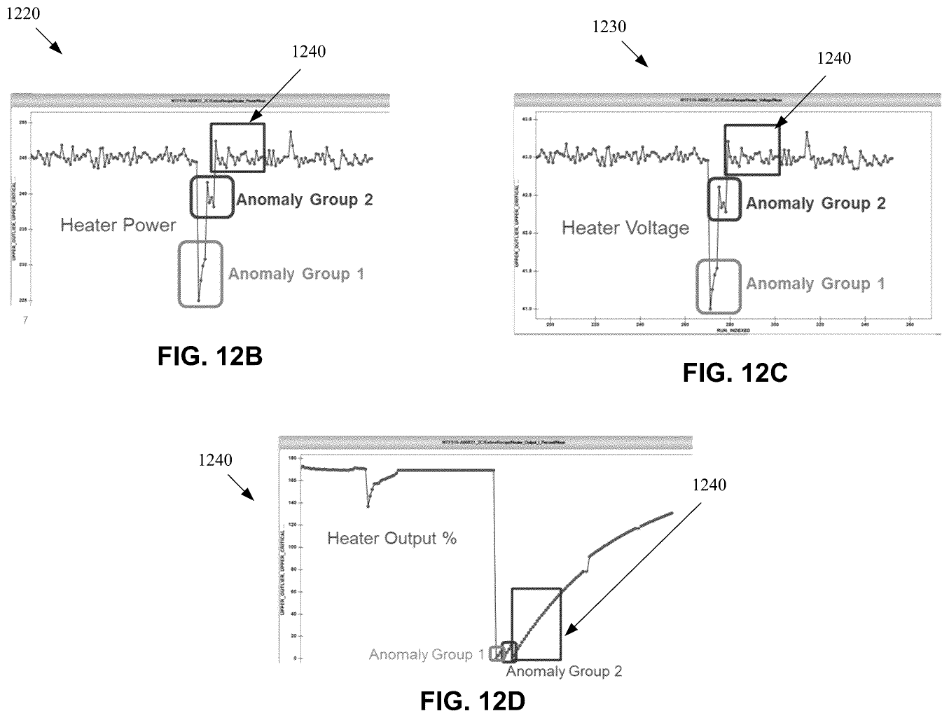

FIG. 12A is another graph 1210 showing output data, for a particular cluster, generated by the ADM 114, according to aspects of the present disclosure. Graph 1210 similar to graph 1110, illustrates the total anomaly score (y-axis) generated during a time period of a process run for a cluster of three sensors. Graphs 1210 shows two identified anomaly groups (anomaly group 1 1220 and anomaly group 2 1230), and a set single sensor anomalies 1240.

FIGS. 12B-12D are graphs 1220, 1230, 1240, respectively, showing sensor statistic output data for respective sensors of the sensor cluster, according to aspects of the present disclosure. In particular, graph 1220 illustrates the heater power (y-axis) generated during the process run (x-axis represents time periods of the process run). Graph 1230 illustrates the heater voltage (y-axis) generated during the process run. Graph 1240 illustrates the heater output (y-axis) generated during the process run. The time periods of the process run can be the same as shown in graphs 1110 and 1210. As shown, in anomaly groups 1 and 2, all three sensors of the cluster are triggered, which signifies that the entire cluster experienced an anomaly (therefore there is a shift in a process tool). The group of sensors indicated by 1240 can indicate misidentified issues. That is, as shown in FIGS. 12B and 12C, the sensor output data for heater voltage and heater output is normal. However, the heater output is low, which indicates that the anomalies are caused by a difference in the process of the manufacturing process (e.g., the process tool is warming up due to the previous drop in voltage and power).

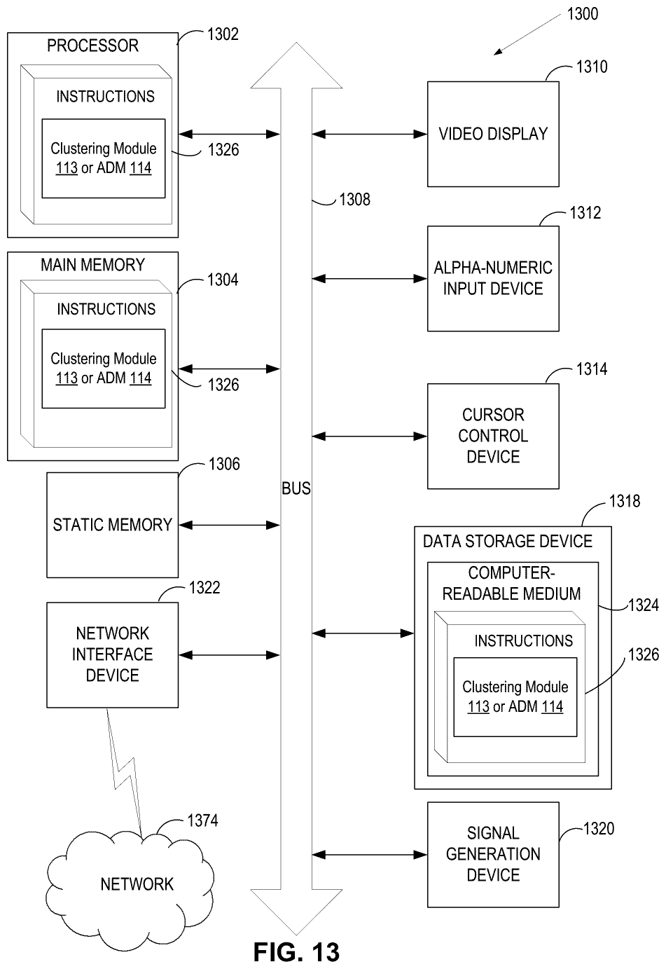

FIG. 13 is a block diagram illustrating a computer system 1300, according to certain embodiments. In some embodiments, computer system 1300 can be connected (e.g., via a network, such as a Local Area Network (LAN), an intranet, an extranet, or the Internet) to other computer systems. Computer system 1300 can operate in the capacity of a server or a client computer in a client-server environment, or as a peer computer in a peer-to-peer or distributed network environment. Computer system 1300 can be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1300 can include a processing device 1302, a volatile memory 1304 (e.g., Random Access Memory (RAM)), a non-volatile memory 1306 (e.g., Read-Only Memory (ROM) or Electrically-Erasable Programmable ROM (EEPROM)), and a data storage device 1316, which can communicate with each other via a bus 1308.

Processing device 1302 can be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 1300 can further include a network interface device 1322 (e.g., coupled to network 1374). Computer system 1300 also can include a video display unit 1310 (e.g., an LCD), an alphanumeric input device 1312 (e.g., a keyboard), a cursor control device 1314 (e.g., a mouse), and a signal generation device 1320.

In some implementations, data storage device 1316 can include a non-transitory computer-readable storage medium 1324 on which can store instructions 1326 encoding any one or more of the methods or functions described herein, including instructions encoding components of FIG. 1 (e.g., SCM 111, SSM 112, clustering module 113, ADM 114, corrective action module 115, etc.) and for implementing methods described herein.

Instructions 1326 can also reside, completely or partially, within volatile memory 1304 and/or within processing device 1302 during execution thereof by computer system 1300, hence, volatile memory 1304 and processing device 1302 can also constitute machine-readable storage media.

While computer-readable storage medium 1324 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and can not have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method, comprising:
obtaining a plurality of datasets associated with a process recipe, wherein each dataset of the plurality of datasets comprises data generated by a plurality of sensors during a corresponding process run performed using the process recipe;
determining, using the plurality of data sets associated with the process recipe, a correlation value between two or more sensors of the plurality of sensors;
responsive to the correlation value satisfying a threshold criterion, assigning the two or more sensors to a cluster; and
generating, during a subsequent process run, an anomaly score associated with the cluster and indicative of an anomaly associated with at least one step of the subsequent process run.

2. The method of claim 1, wherein each dataset of the plurality of datasets comprises at least one of sensor data, statistics data, or task data.

3. The method of claim 1, wherein each dataset of the plurality of datasets comprises a set of arrays, each array indicating statistics data associated with a particular sensor during a particular step of the process recipe.

4. The method of claim 1, wherein the plurality of datasets are selected on a rolling basis corresponding to an oldest process run being replaced with a newest process run.

5. The method of claim 1, further comprising:
identifying a defective data set in the plurality of datasets by determining that the defective data set comprises an amount of anomalies that satisfies a defective set threshold criterion; and
removing the defective dataset from the plurality of datasets.

6. The method of claim 1, wherein generating the anomaly score comprises:
obtaining a reduced representation of a plurality of sensor statistics representative of data collected by the cluster of two or more sensors;
generating, using a plurality of outlier detection models, a plurality of outlier scores, wherein each of the plurality of outlier scores is generated based on the reduced representation of the plurality of sensor statistics using a respective one of the plurality of outlier detection models; and
processing the plurality of outlier scores using a detector neural network to generate the anomaly score.

7. The method of claim 1, wherein the correlation value is determined using at least one of Pearson correlation method, Kendall correlation method, Spearman's correlation method, Quotient correlation method, Phik correlation method, density-based spatial clustering of applications with noise (DBSCAN) algorithm, or SAX (Symbolic Aggregate approximation) correlation method.

8. The method of claim 1, wherein the correlation value is determined using a machine-learning model.

9. The method of claim 1, further comprising:
responsive to determining that the anomaly score satisfies a corrective action threshold criterion, performing a corrective action.

10. An electronic device manufacturing system, comprising:
a memory device; and
a processing device, operatively coupled to the memory device, to perform operations comprising:
obtaining a plurality of datasets associated with a process recipe, wherein each dataset of the plurality of datasets comprises data generated by a plurality of sensors during a corresponding process run performed using the process recipe;
determining, using the plurality of data sets associated with the process recipe, a correlation value between two or more sensors of the plurality of sensors;
responsive to the correlation value satisfying a threshold criterion, assigning the two or more sensors to a cluster; and
generating, during a subsequent process run, an anomaly score associated with the cluster and indicative of an anomaly associated with at least one step of the subsequent process run.

11. The electronic device manufacturing system of claim 10, wherein each dataset of the plurality of datasets comprises at least one of sensor data, statistics data, or task data.

12. The electronic device manufacturing system of claim 10, wherein each dataset of the plurality of datasets comprises a set of arrays, each array indicating statistics data associated with a particular sensor during a particular step of the process recipe.

13. The electronic device manufacturing system of claim 10, wherein the plurality of datasets are selected on a rolling basis corresponding to an oldest process run being replaced with a newest process run.

14. The electronic device manufacturing system of claim 10, wherein the operations further comprise:
identifying a defective data set in the plurality of datasets by determining that the defective data set comprises an amount of anomalies that satisfies a defective set threshold criterion; and
removing the defective dataset from the plurality of datasets.

15. The electronic device manufacturing system of claim 10, wherein generating the anomaly score comprises:
obtaining a reduced representation of a plurality of sensor statistics representative of data collected by the cluster of two or more sensors;
generating, using a plurality of outlier detection models, a plurality of outlier scores, wherein each of the plurality of outlier scores is generated based on the reduced representation of the plurality of sensor statistics using a respective one of the plurality of outlier detection models; and
processing the plurality of outlier scores using a detector neural network to generate the anomaly score.

16. The electronic device manufacturing system of claim 10, wherein the correlation value is determined using at least one of Pearson correlation method, Kendall correlation method, Spearman's correlation method, Quotient correlation method, density-based spatial clustering of applications with noise (DBSCAN) algorithm, Phik correlation method, or SAX (Symbolic Aggregate approximation) correlation method.

17. The electronic device manufacturing system of claim 10, wherein the correlation value is determined using a machine-learning model.

18. The electronic device manufacturing system of claim 10, wherein the operations further comprise:
responsive to determining that the anomaly score satisfies a corrective action threshold criterion, performing a corrective action.

19. A non-transitory computer-readable storage medium comprising instructions that, when executed by a processing device operatively coupled to a memory, performs operations comprising:
obtaining a plurality of datasets associated with a process recipe, wherein each dataset of the plurality of datasets comprises data generated by a plurality of sensors during a corresponding process run performed using the process recipe;
determining, using the plurality of data sets associated with the process recipe, a correlation value between two or more sensors of the plurality of sensors;
responsive to the correlation value satisfying a threshold criterion, assigning the two or more sensors to a cluster; and
generating, during a subsequent process run, an anomaly score associated with the cluster and indicative of an anomaly associated with at least one step of the subsequent process run.

20. The non-transitory computer-readable storage medium of claim 19, wherein generating the anomaly score comprises:
obtaining a reduced representation of a plurality of sensor statistics representative of data collected by the cluster of two or more sensors;
generating, using a plurality of outlier detection models, a plurality of outlier scores, wherein each of the plurality of outlier scores is generated based on the reduced representation of the plurality of sensor statistics using a respective one of the plurality of outlier detection models; and
processing the plurality of outlier scores using a detector neural network to generate the anomaly score.
